(19) United States
(12) Patent Application Publication
(10) Pub. No.: US 2024/0257036 A1
(43) Pub. Date: Aug. 1, 2024

(54) SUPPLIER MANAGEMENT SERVICE SYSTEM

(71) Applicant: PartnerElement Inc., San Francisco, CA (US)

(72) Inventors: Arina Bobrova, San Francisco, CA (US); Alvin Yates, San Leandro, CA (US)

(21) Appl. No.: 18/420,490

(22) Filed: Jan. 23, 2024

Related U.S. Application Data
(60) Provisional application No. 63/442,065, filed on Jan. 30, 2023.

(51) Int. Cl. G06Q 10/0835; G06Q 30/018; H04L 67/306

(52) U.S. Cl. CPC G06Q 10/0835; G06Q 30/018; H04L 67/306

(57) ABSTRACT

A supplier management service system includes a processor and a memory. The processor is configured to monitor incoming correspondence; determine an associated supplier for the incoming correspondence; aggregate associated correspondence to the associated supplier; determine one or more supplier deals based on the incoming correspondence and the associated correspondence, where a supplier deal of the one or more supplier deals has an associated deal type, an associated deal stage, and deal participants; tag the supplier deal with one or more associated topic labels; and update a database with the incoming correspondence with the associated supplier, the one or more supplier deals with the associated deal type, the associated deal stage, deal participants, and the one or more associated topic labels in the database. The memory is coupled to the processor and configured to provide the processor with instructions.

### CROSS REFERENCE TO OTHER APPLICATIONS

This application claims priority to U.S. Provisional Patent Application No. 63/442,065 entitled SUPPLIER MANAGEMENT SERVICE SYSTEM filed Jan. 30, 2023 which is incorporated herein by reference for all purposes.

### BACKGROUND OF THE INVENTION

There are two problems around supplier management in large organizations: (1) heads of procurement have no visibility into real-time interactions between business departments and suppliers, and (2) key supplier information, such as supplier contacts, introductory decks, or roadmaps, exists only in employees' inboxes and cloud drives and is not easily accessible when needed. The first problem reduces the efficacy of procurement because, by the time the team is engaged, business stakeholders have already selected a supplier. The second problem creates inefficiencies for everyone who deals with suppliers as there is no single place to get the latest information about supplier relationships.

### BRIEF DESCRIPTION OF THE DRAWINGS

Various embodiments of the invention are disclosed in the following detailed description and the accompanying drawings.

FIG. 1 is a diagram illustrating an embodiment of a system for a supplier management service system.

FIG. 2 is a diagram illustrating an embodiment of a supplier management service system.

FIG. 3 is a diagram illustrating an embodiment of a graph display for a user.

FIG. 4 is a diagram illustrating an embodiment of a flow for importing supplier data.

FIGS. 5A and 5B are diagrams illustrating embodiments of supplier matching percentages.

FIG. 6 is a diagram illustrating an embodiment of information to be saved from an email message.

FIG. 7 is a diagram illustrating an embodiment of record display screen of information.

FIG. 8 is a diagram illustrating an embodiment of an email scanning preferences setting user interface display.

FIG. 9 is a diagram illustrating an embodiment of results review user interface display.

FIG. 10 is a diagram illustrating an embodiment of a content and attachment saving user interface.

FIG. 11 is a diagram illustrating an embodiment of a user interface display depicting who is connected to supplier Café Art.

FIG. 12 is a diagram illustrating an embodiment of a user interface display depicting who is connected to an organization unit.

FIG. 13 is a diagram illustrating an embodiment of a user interface display depicting supplier information.

FIG. 14 is a diagram illustrating an embodiment of a user interface display depicting supplier information.

FIG. 15 is a diagram illustrating an embodiment of a user interface display depicting supplier information.

FIG. 16 is a diagram illustrating an embodiment of a user interface display depicting supplier information.

FIG. 17 is a diagram illustrating an embodiment of an email data processing flow.

FIG. 18 is a diagram illustrating an embodiment of a user interface displaying a dashboard.

FIG. 19 is a diagram illustrating an embodiment of a user interface displaying supplier contacts.

FIG. 20 is a diagram illustrating an embodiment of a user interface displaying supplier details.

FIG. 21 is a diagram illustrating an embodiment of a user interface displaying supplier contacts.

FIG. 22 is a diagram illustrating an embodiment of a user interface displaying supplier contacts.

FIG. 23 is a diagram illustrating an embodiment of a user interface displaying a deal closing.

FIG. 24 is a diagram illustrating an embodiment of a user interface displaying a summary for procurement engagement.

FIG. 25 is a diagram illustrating an embodiment of a user interface displaying a dashboard.

FIG. 26 is a diagram illustrating an embodiment of a user interface displaying a dashboard.

FIG. 27A is a diagram illustrating an embodiment of a user interface displaying an interactions by team frame.

FIG. 27B is a diagram illustrating an embodiment of a user interface displaying a dashboard.

FIG. 28 is a diagram illustrating an embodiment of a user interface displaying a dashboard.

FIG. 29 is a diagram illustrating an embodiment of a user interface displaying an email filtering dashboard.

FIG. 30 is a diagram illustrating an embodiment of a user interface displaying an email filtering dashboard.

FIG. 31 is a flow diagram illustrating an embodiment of a process for a supplier management service system.

FIG. 32 is a flow diagram illustrating an embodiment of a process for a supplier management service system.

FIG. 33 is a flow diagram illustrating an embodiment of a process for a supplier management service system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A supplier management service system is disclosed. The system includes a processor. The processor is configured to monitor incoming correspondence; determine an associated supplier for the incoming correspondence; aggregate associated correspondence to the associated supplier; determine one or more supplier deals based on the incoming correspondence and the associated correspondence, wherein a supplier deal of the one or more supplier deals has an associated deal type, an associated deal stage, and deal participants; tag the supplier deal with one or more associated topic labels; and update a database with the incoming correspondence with the associated supplier, the one or more supplier deals with the associated deal type, the associated deal stage, deal participants, and the one or more associated topic labels in a database.

In some embodiments, the supplier management system is designed to (1) detect prospective suppliers in the incoming correspondence, (2) aggregate incoming correspondence related to a purchase of a supplier deal, and (3) place a deal into stages of the purchasing process (e.g., exploration, negotiations, deal closure, etc.). For example, the system scans appropriate incoming emails and/or text messages (e.g., only selected allowed user(s), group(s), domain(s), etc. are monitored and not any banned user(s), group(s), domain(s) are monitored). The incoming emails or texts are used to determine an associated existing or prospective supplier and the system aggregates other stored information (e.g., other correspondence or metadata related to the supplier) to determine one or more deals, their type (e.g., a new contract, a renewal, etc.), and their stage (e.g., exploration, negotiation, closure, etc.) that are associated with that supplier. Engagement with the supplier is tracked by identifying team members and supplier contacts and their respective titles and other associated information is extracted from the incoming correspondence. The correspondence is also associated with keywords or topic labels. The information is then stored associated with the supplier so that it can be easily searched and displayed for other team members to provide a rich picture of data related to any given supplier and the interactions that the company and its employees have with that supplier.

In some embodiments, the incoming correspondence comprises email correspondence. In some embodiments, the incoming correspondence comprises instant messaging correspondence. In some embodiments, monitoring incoming correspondence comprises scanning email inboxes. In some embodiments, monitoring incoming correspondence comprises scanning an instant messaging service. In some embodiments, tagging the incoming correspondence includes using a machine-learning model to detect a prospective deal with a supplier, the deal's type and stage, and to identify the one or more associated topic labels or keywords. In some embodiments, a topic label of the one or more associated topic labels comprises one or more of: pricing, negotiation, contracts, payments, products, services, catalogs, scope, and/or new engagement.

In some embodiments, the topic label pricing is associated with keywords: pricing, price, cost, discount, total cost of ownership (TCO), and/or value. In some embodiments, the topic label new engagement is associated with keywords/phrases: [supplier name] introduction, learn more, thanks for the interest, request for information, request for information (RFI), request for quote (RFQ), request for proposal (RFP), and/or competitive bid. In some embodiments, email attributes associated with the topic label new engagement are: supplier contact title, account representative, sales development representative, and/or account executive. In some embodiments, the topic label negotiation is associated with keywords/phrases: cost, discount, scope, terms, schedule, multi-year, key personnel, and/or milestones. In some embodiments, the topic label contract is associated with keywords/phrases: contract, agreement, statement of work (SOW), statement of work, master service agreement (MSA), non-disclosure agreement (NDA), mutual non-disclosure agreement (MNDA), order form, software agreement, vendor agreement, rider agreement, exhibits, purchase order (PO), start date, end date, renewal, extension, data privacy and security, service level agreement (SLA), pricing schedule, description of services, intellectual property (IP), warranties, governing law, and/or support training.

A supplier management service system is disclosed. The system includes an interface and a processor. The interface is configured to display deals between business teams and suppliers in a given timeframe organized by engagement stages. The processor is configured to query a database for deals in a given timeframe by deal type, engagement stage, procurement engagement, business team, and supplier. In some embodiments, the interface is configured to receive an inquiry regarding a supplier, and the processor is configured to query a database for associated correspondence and associated tags of the supplier; and provide a portion of the associated correspondence (e.g., content or information associated with the correspondence—for example, a sender, a recipients, a cc user, a subject, a content body, etc.), and a portion of the associated tags of the supplier (e.g., information or metainformation stored associated with the supplier in a database).

In some embodiments, the first portion comprises the associated correspondence related to a selected tag. In some embodiments, the selected tag comprises a predetermined number of most recent (in the past six months) contacts with the supplier. In some embodiments, the selected tag comprises a predetermined number of most recent correspondences with the supplier. In some embodiments, the selected tag comprises a predetermined number of most recent topics with the supplier. In some embodiments, the first portion comprises a recommendation related to the supplier. In some embodiments, the first portion comprises a risk related to the supplier. In some embodiments, the first portion comprises a status related to the supplier. In some embodiments, wherein the first portion comprises a health related to the supplier.

A supplier management service system is disclosed. The system includes an interface and a processor. The interface is configured to display current and prospective suppliers engaging in prospective deals with the company's business teams. In some embodiments, the interface is configured to receive one or more supplier identifiers, such as names, domains in a form of supplier email or website, or tax identifiers, such as EIN. The processor is configured to determine profile data associated with the one or more supplier identifiers; determine associated correspondence, wherein the associated correspondence comprises correspondence associated with the one or more supplier identifiers; aggregate associated correspondence related to a prospective purchase to a deal; assign the associated deals with their engagement stages; tag the associated deals with one or more associated topic labels; and store the one or more supplier identifiers and the associated deals in a database.

In some embodiments, determining profile data includes determining a domain name associated with a supplier of the one or more supplier identifiers, if the supplier domain is not one of them. In some embodiments, determining profile data includes validating a domain name associated with a supplier of the one or more supplier identifiers. In some embodiments, determining profile data comprises matching a supplier identifier of the one or more supplier identifiers with a company in a third-party database. In some embodiments, the public database comprises a company information third-party database (e.g., Crunchbase, ZoomInfo, etc.). In some embodiments, the correspondence comprises email correspondence or instant messaging correspondence. In some embodiments, determining the correspondence comprises scanning email inboxes (e.g., Outlook™, gmail, yahoo, etc.) or scanning an instant messaging service (e.g., Slack™, Teams™, etc.). In some embodiments, scanning excludes emails with specific domains or email addresses. In some embodiments, tagging the correspondence includes using a machine learning model to detect a prospective deal with a supplier and the deal's type, and identify the one or more associated topic labels. In some embodiments, a deal stage reflects the stage in the purchasing process, such as exploration, negotiation, or deal closure. In some embodiments, tagging the correspondence includes using a machine-learning model to identify the one or more associated topic labels. In some embodiments, a topic label of the one or more associated topic labels comprises one or more of: pricing, negotiation, payments, contract, products, services, catalogs, and/or new engagement (e.g., an introduction, new work, etc.).

In various embodiments, the system is designed to be a tool for sourcing managers (e.g., commodity sourcing managers, category sourcing managers, supply sourcing managers, etc.), employees or heads of procurement, employees or heads of strategic sourcing, or any other appropriate user involved in the sourcing of items for an organization.

In some embodiments, the system addresses an organization's inefficient saving of supplier contacts, attachments, and emails for shared access for procurement by the portion of the organization involved in procurement. Typically, current solutions for these tasks include manually maintained spreadsheets with contacts and shared drives with attachments. This means that it is difficult to understand the context of a relationship with a supplier company and email communications with the supplier company. Simple questions related to the relationship are difficult to locate including the start of the supplier relationship for the organization, the spend with the supplier (e.g., over a period such as a year, a quarter, a month, etc.), the supplier size, revenue, location (e.g., local location, headquarter location, etc.), whether there is an active contract with the supplier, whether there is a non-disclosure agreement with the supplier, who was the last person interacting with the supplier and what was the topic of the interaction, what was the supplier performance, etc.

In some embodiments, the system improves the computer by enabling (1) efficient information sharing for a procurement team and (2) efficient access to information about suppliers for faster and better decision-making by automatically loading a database with information regarding the interactions of the procurement team with suppliers in addition to automatically loading a database with information regarding the supplier companies that the procurement team is interacting with. In some embodiments, the system improves the computer by automatically monitoring, filtering, and storing in a database information related to specific companies and not storing information related to specific domains, users, groups, etc. In some embodiments, the system improves the computer by automatically providing a notification for the procurement team about new supplier deals across the company. In some embodiments, the system improves the computer by automatically updating a status stored in a database in response to monitoring a stream of received correspondence and determining an associated tag for that correspondence. In some embodiments, the system improves the computer by automatically updating database entries related to the tag in the database related to specific users, suppliers, groups and/or notifying a user/group of the tag or automatically setting up an outgoing communication for the user, group, supplier company in response to identifying a tag associated with a supplier company.

In some embodiments, the system improves the computer by automatically updating databases or systems used by other business teams outside of procurement to update information where the external database treats the system as the source of truth for information related to specific users and supplier companies that the organization is currently or potentially engaged with. In some embodiments, the system improves upon the computer by generating configurable reports that are directly loaded into systems used by other business teams outside of procurement.

In some embodiments, the system identifies supplier contact by comparing the domain in a contact's email to a list of domains associated with suppliers. In some embodiments, a domain mapping might be incorrect—in some cases, a secondary check is performed by checking a third-party database to validate the domain mapping. In some embodiments, if the domain is not found, the user can still search existing suppliers using the system and save a new contact (and other email attributes and data) to an existing supplier, thus linking the contact's domain to the supplier's list of domains.

In some embodiments, the system has a user interface display showing a supplier view. In this supplier view, the system displays a company profile and allows the user to open the detailed company view in the web application.

In some embodiments, the system derives relevant contacts and provides tools for their quick saving to the supplier profile:
a. The system distinguishes between new and existing contacts and attachments so that the user saves only new contacts or adds to existing contacts;
b. The system distinguishes between personal emails (e.g., john@acme.com) and group ones (e.g., billing@acme.com) and prioritizes personal emails for saving information associated with the personal email in the database for suppliers;
c. The system also skips irrelevant emails, such as noreply@acme.com; and
d. The system allows the user to manually tag or add notes to the contact upon saving to clarify contact usage to other employees.

In some embodiments, contact information is saved including names and emails.

In some embodiments, the system derives relevant attachments and provides tools for saving the attachments to the supplier profile:
a. The system categorizes attachments into topics relevant for Procurement—for example, Introduction, Product Specification, Pricing, Payment, or Contract—to make it easier for the user to decide on their relevance to the team;
b. The system distinguishes between new and existing attachments so that the user saves only the new ones; and
c. The system allows the user to manually tag or add notes the attachment upon saving.

In some embodiments, the system allows saving the current email or email thread as a tagged attachment to a supplier record.

In some embodiments, the system allows searching existing suppliers and supplier contacts directly using a plugin:
a. The search includes no or minimal filtering—for example, a toggle to include inactive suppliers;
b. The search has auto-complete; and
c. The search returns only the company profile and allows the user to open the detailed supplier view in the web application.

In some embodiments, the system alerts a user if a supplier is “currently” interacting with other employees in order to enable coordinated communication. In some embodiments, a communication is considered “current” if it occurs within 7 days of today.

In some embodiments, the system notifies employees engaging with a supplier, existing or prospective, about third-party compliance requirements, procurement policies, and opportunities to save time and money by using alternative suppliers, including the ones with active contracts.

In some embodiments, a contact's title is derived from a search of an email body. In some embodiments, the system has fine grained access control to information extracted from the emails. For example, contract proposed terms, amounts, may be indicated as being accessible by only the email recipient, and the date and time and contact person name and title might be accessible by the procurement group.

In some embodiments, the system automatically creates new supplier records or requests to a user or administrator to create a new supplier record.

In some embodiments, the system is able to search supplier records in the database including searching by supplier company name, email address of contact, contact name, contact phone number, etc.

In some embodiments, the system enables determining whether the email matches with anyone associated with a user's suppliers. In some embodiments, once a match is found, a user is able to view via a user interface a supplier profile, a contact profile, an interactions graph, etc. In some embodiments, other stakeholders are alerted in the event that they are also in contact, correspondence, or otherwise talking with the supplier. In some embodiments, if a match is not found, a user or the system is able to create a new supplier, add a contact for the new supplier, add notes to the contact, etc.

In various embodiments, the system is targeted for a user—for example, a category manager, a sourcing Manager, a Supplier Relationship Manager, or any other procurement or acquisition personnel.

In some embodiments, the system is able to satisfy the following requests by a category manager:
The category manager wants to have early company-wide visibility into ongoing deals between suppliers and business teams the category manager supports;
The category manager wants to have an up-to-date library of valid supplier contacts so that he can quickly identify the right people or groups on the supplier side for sourcing questions. For example, who to send RFP to? Does the company provide the services that the category manager needs? What is the status of X project? Note that the library should exclude any “no-reply” emails (e.g., email@mail.companyname.com, no-reply@email.companyname.com);
The category manager wants to distinguish between personal email addresses and groups ones, such as billing or support, so that the category manager can decide what the fastest way to get answers is;
For personal emails, the category manager wants to see the contact's name, email, phone, title, and location/address to decide if the person is the right one for the question;
   Example:
      Name: John Doe
      Title: Business Risk, OFAC/Sanctions
      Email: jdoe@mybank.com
      Address: 387 Park Ave South
      2nd Floor
      New York, NY 10016
For group emails, the category manager wants to see the group name, email, phone, and location/address to decide if the group can help with the question;
   Example:
      Startup Banking Support Team
      (800)555-6677 or (408)555-7347
      StartupBanking@mybank.com
The category manager wants to see the last day of interaction with the person to know if the relationship is current;
The category manager wants to know if the contact's email address is still valid so that time is not wasted contacting people who have left a supplier's organization;
The category manager would like to understand the context(s) of the relationship with the supplier contact to determine if the contact fits a specific business need. For example, the system can tag a contact as encountered in pricing discussions or new product offerings or billing;
The category manager wants to quickly find a supplier contact by supplier name, contact name, location, contact's title, or purpose;
   Examples:
      Dell CA (California)
      MyBank billing
      Crunchbase sales
      Clerky support
      Etan Crunchbase
      Etan sales
The category manager wants to pull a report of all the contacts identified from email scanning so that the category manager can efficiently validate the results and share them with the team.

In some embodiments, the system is able to satisfy the following requests by a category manager:
The category manager wants to see the latest documents received from suppliers to help understand the nature and state of the relationships at a glance (e.g., the system searches and filters for documents received from a supplier in a supplier database);
The category manager wants to see categories of interest (e.g., the system searches and filters for documents or correspondence related to a category in a supplier database);
The category manager would like to specify for an organization what categories of documents should be saved to the supplier profile to reduce clutter (e.g., based at least in part on an attachment classification);
The category manager wants to see only the documents originally sent by suppliers and not the forwarded ones to reduce clutter (e.g., the system searches and filters for documents received from a supplier and not forwarded in a supplier database);
The category manager wants to quickly locate relevant supplier attachments on the supplier profile to get the answers needed as fast as possible;
If there are multiple documents of the same category, the category manager wants to immediately see only the latest 2 or 3 and navigate to the rest only if needed;
The category manager wants to immediately identify the file's relevance to the need at hand—for example, contract, pricing, or product information;
The category manager wants to view a file's date sent to assess its recency; and
The category manager wants to view who originally sent and received the file so that the person can be asked if any questions arise.

In various embodiments, categories of interest comprise:
A company profile—for example:
   Company introduction presentation
      MyBank-startup-banking-overview.pdf
   Product/Services
      Roadmaps
      Product specs/sheets:
         MyBank_edge_product_sheet 2022-07-21.pdf
      Catalogs
   Performance
      KPI spreadsheets
      Supplier business review decks
A contract—for example:
   every legal document including non-disclosure agreements (NDAs), master purchase agreements (MPAs), letters of intent (LOIs), statements of work (SOWs), etc.
      Deposit Agreement and Disclosure Statement 5-31-20.pdf
      MyBank_Go_Online_Banking_Enrollment_Form_Custom_Enroll ment_No_Approvers_2022.05.18jt.pdf
      Ken Smith—Non-Disclosure Agreement (1008215v1).pdf
      PartnerElement Inc. and Jane Davis—Consulting Agreement (996334v1).pdf
Operations—for example:
   Forecast
   Shipments/supply (e.g., what was shipped)
   Purchase orders (Pos)
Pricing (or quotation)—for example, anything related to price:
   RFP
   Billing:
      Invoice-7F921B02-001.pdf
      Reciept-2517-6745.pdf
   Pricing
      External Data Licensing API Endpoints—Pricing Tiers (Updated January 2022).xlsx

In various embodiments, a user interface is able to present a display showing email scanning results—for example, a display showing charts with topics, a display showing people and attachments, etc. In some embodiments, a user interface is able to present a display showing a graph indicating who is connected to a particular supplier. In some embodiments, a user interface is able to present a display showing a supplier summary in a hierarchy.

In some embodiments, the supplier data provided by customers is linked with company information, such as company logo, size, revenue, and domain list, from data vendors using exact and fuzzy matching of company names and domains.

In some embodiments, the supplier data is linked with other data provided by customers.

In some embodiments, the system integrates its web application with a customer email and instant messaging (IM) system.

In some embodiments, the supplier contacts, internal stakeholder contacts, conversation topics, and/or categorized attachments are retrieved from email and IM systems. In some embodiments, the system is able to distinguish between the entity and individual emails to prioritize the individual email addresses in contact pages. In some embodiments, the system uses a language model for name tagging people (e.g., a Bidirectional Encoder Representations from Transformers). In some embodiments, the system categorizes emails into topics, such as pricing, contracts, and new work, based on the email content: addresses, subject, body, and attachments. In some embodiments, the topics help the system identify and save the most important emails and attachments from the inbox. In some embodiments, the system creates a searchable directory of supplier profiles in a web application. In some embodiments, a supplier profile includes general information, such as company name, size, and revenue, company locations, internal and external contacts, files, such as a company introduction presentation, and an interaction map based on the email and IM communication between the supplier contacts and company employees. In some embodiments, the system includes an email plug-in for supplier look-up and ad hoc saving of supplier contacts and attachments. In some embodiments, the system presents interactions between suppliers and company employees in an intuitive way using a graph database and analytics platform in a web application.

In some embodiments, the system components comprise:
1. Login flow based on the default Auth0 login page with the protection of authenticated routes & pages
2. Home/Dashboard with an empty state
3. Onboarding flow:
   a. Steps to add supplier data
      i. Text file upload with field matching
      ii. Import results: numbers and examples
         1. Ability to review suppliers not matched to the data vendor company profile
         2. Ability to change the linking of original supplier records uploaded by customers to the system supplier profiles
   b. Steps to set up email plug-in
   c. Steps to launch email inbox scanning
      i. Email integration setup tasks
      ii. Scanning results review: numbers and examples
         1. Supplier contacts, internal stakeholder contacts, email conversation topics, categorized attachments, and interaction dates
4. Search functionality with auto-complete: the ability to find supplier profiles by any attribute of the supplier profile
5. Supplier profile pages: general information, company structure and spend, locations, supplier contacts, employee contacts, supplier interactions, files, and attachments
6. Interactions graph based on neo4j widget embedding.

In some embodiments, the system uses one or more third-party application programming interfaces (APIs) match an email address with a domain name with a company name. In some embodiments, two data sets are used (e.g., ZoomInfo and Crunchbase) for identifying matches. In some embodiments, a first data set check is used followed by a a second data set check.

In various embodiments, the system uses one or more of the following matching scenarios:
1. Exact_match_single_domain: For example, a domain exact match is found, and there is a single result (e.g., from a third-party site such as Crunchbase)
   a. Parent supplier is set to the Crunchbase record matching the domain
      Note: in some cases, when the system has both Crunchbase and ZoomInfo, if the name differs between Crunchbase and ZoomInfo, pick the name in ZoomInfo.
   b. Example: award.com
2. Exact_match_fuzzy_subsidiary: domain exact match found, however there are multiple Crunchbase results
   a. Single supplier name after fuzzy matching
      Parent supplier=the Crunchbase record with the highest confidence score
      Example: aws
      In some embodiments, a threshold is applied to the confidence score to qualify the match.
   b. Multiple supplier names after fuzzy matching
      Parent supplier is not set.
         Note: when there is a match using ZoomInfo, if there is a single exact match in ZoomInfo, parent supplier is set to the ZoomInfo result; otherwise, fuzzy matching is used using ZoomInfo.
      Example: Optum.com
3. Crunchbase domain not found, but ZoomInfo is found
   a. Parent supplier is set to the ZoomInfo record matching the domain
4. ERROR: domain not found (e.g., a domain name is misspelled)
   Parent supplier is not set.

In some embodiments, the system includes a database storing a supplier list comprising a supplier identifier, a supplier name (unique), and a supplier domain. In some embodiments, the system includes a database storing a company domain name. In some embodiments, the system examines email attachment types including file types xls, xlsx, doc, docx, pdf, zip, or tiff. In some embodiments, the system does not examine email attachment types including jpeg, jpg, or png files. In some embodiments, the system includes an API to derive topics and keywords from email threads based on the email content: addressees, subject, body, and/or attachments. In some embodiments, the system includes an API to return a personal email classifier. In some embodiments, the personal email classifier is determined based on a model (e.g., a BERT model) for people name tagging.

In some embodiments, the system uses an email API (e.g., a gmail API) to find all emails sent by or addressed to contacts of registered supplier domains and save the key email attributes to a supplier record. For example, the system finds unique messages to and from suppliers:
a. For each email thread:
   i. Collect metadata: From, To, First message Date, Last message Date, count of messages in the thread;
      1. For later: Subject, Cc, Bcc;
   ii. Collect attachments: files, file names;
      1. Only save attachments in the eligible formats;
      2. For later: Only save attachments when the message subject, body, or attachment name contains one of the keywords;
   iii. Tag messages based on the keywords in the message subject, body, or attachment name.

As another example, the system adds new contacts and stakeholders to supplier records:
a. Contact attributes: name, email
b. Context: from, to, last interaction date, and tag
c. for each user retain the link to the original message for interaction context

As another example, the system adds tagged attachments to the supplier records (e.g., Context: from, to, the date file was sent, and tag).

In some embodiments, the system improves the computer by making efficient and automatic the acquisition of data related to suppliers. For example, upon determining a new domain from a supplier (e.g., by identifying a domain from an email address), an automated acquisition and storing of information related to the domain is achieved by fetching data from third party site(s) to load into a supplier database. In some embodiments, the efficiency and automation is aided using the ability to scan emails and extract relevant information and ignore unimportant information. In some embodiments, the system automatic alerting and automatic responses to supplier emails.

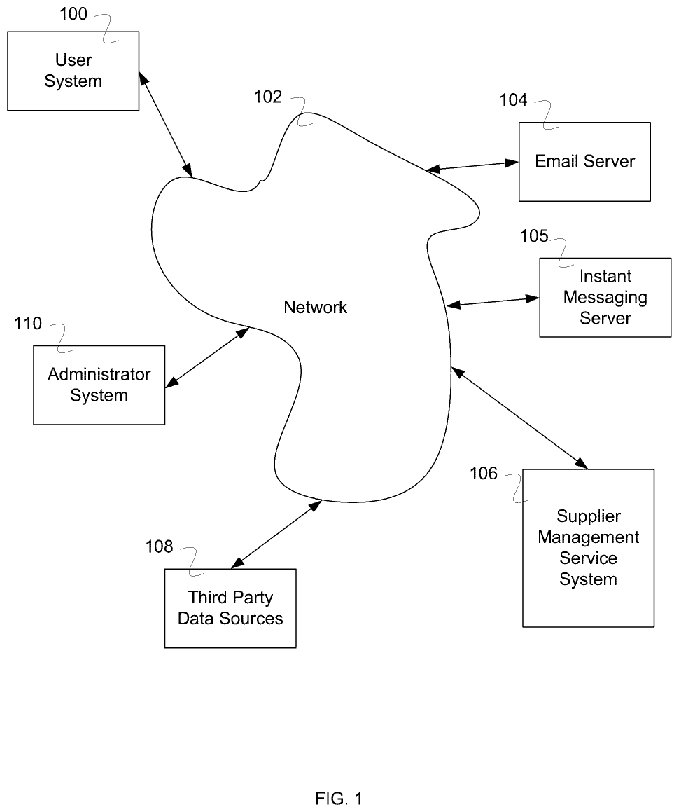

FIG. 1 is a diagram illustrating an embodiment of a system for a supplier management service system. In the example shown, user system 100 enables a user to use supplier management service system 106. The user is able to use supplier management service system 106 to find information in order to assist in obtaining suppliers for an organization—for example, contacting, comparing, negotiating, signing, etc. Supplier management service system 106 searches emails of the user and of other users associated with the organization to identify interactions with suppliers by interacting (e.g., using an application programming interface (API)) with email server 104. Supplier management service system 106 identifies and stores information in emails or attached to emails in a supplier database. The email information is stored related to the name of a supplier as identified using email information (e.g., a domain name associated with an email address of the supplier). Supplier management service system 106 is able to acquire information related to a supplier by querying third party sources 108. In some embodiments, upon initially identifying a new supplier, supplier management service system 106 queries one or more third party sources 108 to gather information related to the new supplier (e.g., company name, company size, company revenue, company location(s), company officer(s), company review(s), company founding date, etc.). User using user system 100 can also query supplier management service system 106 to find information related to a supplier—for example, company information and internal organization information related to the supplier (e.g., prior orders, current organization contacts, on-going email exchanges, current state of interactions with supplier, etc.). Supplier management service system 106 is also able to provide graphical display of information related to the supplier.

Administrator system 110 is used by an administrator to manage supplier management service system 106 (e.g., upgrading new software, installing software, configuring software, etc.).

User system 100, supplier management service system 106, email server 104, third party 108, and administrator system 110 communicate using network 102. In various embodiments, network 102 comprises one or more of: a wired network, a wireless network, a local area network, a wide area network, a cellular network, a satellite network, ethernet, the world wide web, or any other appropriate network.

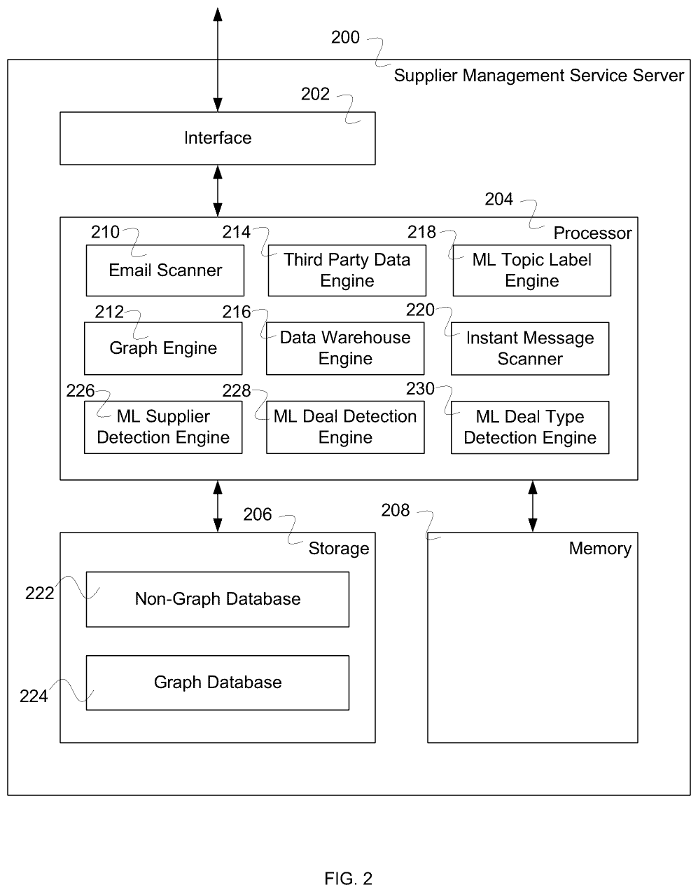

FIG. 2 is a diagram illustrating an embodiment of a supplier management service system. In some embodiments, supplier management service system 200 is used to implement supplier management service system 106 of FIG. 1. In the example shown, supplier management service system 200 includes interface 202, processor 204, storage 206, and memory 208. Processor 204 includes email scanner 210, graph engine 212, third party data engine 2014, data warehouse engine 216, ML topic label engine 218, instant message scanner 220, ML supplier detection engine 226, ML deal detection engine 228, and ML deal type detection engine 230. Storage 206 includes non-graph database 222, and graph database 224. Email scanner 210 and instant message scanner 220 monitor incoming correspondence and determine an associated supplier for the incoming correspondence. ML supplier detection engine 226 identifies an associated existing or prospective supplier in the incoming correspondence using a machine learning model to determine, given an input message, with the sender, recipient, cc addresses, subject, and/or body, whether the sender of the input message is a supplier or a prospective supplier for the recipient. ML deal detection engine 228 aggregates correspondence across email scanner 210 and instant messaging scanner 220 related to a potential purchase as a supplier deal. ML deal type detection engine 230, using a machine learning model, detects whether the incoming correspondence pertains to a renewal of an existing contract. ML topic label engine 218, using a machine learning model, determines tags for the incoming correspondence with one or more associated topic labels. In various embodiments, a topic label comprises pricing, payments, contract, products, services, catalogs, new engagement, or any other appropriate label. Data warehouse engine 216 updates database(s) (e.g., non-graph database 222 and/or graph database 224) with the incoming correspondence with the associated supplier and the one or more associated topic labels in the database(s).

Interface 202 is configured to receive one or more supplier identifiers. In various embodiments, a supplier identifier of the one or more supplier identifiers comprises a name, a domain in a form of a supplier email or a website, a tax identifier, an EIN, or any other appropriate identifier. Processor 204 determines profile data associated with the one or more supplier identifiers. In various embodiments, data warehouse engine 216 and/or third party data engine 214 is are used to determine profile data from database(s) (e.g., querying non-graph database 222 and/or graph database 224) and/or third party data sources (e.g., querying third party data sources 108 of FIG. 1 and providing profile data and storing data received in response to the query in non-graph database 222 and/or graph database 224 for future queries/searches), respectively. Processor 204 is also configured to determine associated correspondence that is associated with the one or more supplier identifiers. ML topic label engine 218 tags the associated correspondence with one or more associated topic labels. Data warehouse engine 216 stores (e.g., if not already stored) the one or more supplier identifiers and the associated correspondence and one or more associated topic labels in one or more databases (e.g., non-graph database 222 and/or graph database 224). In various embodiments, determining the profile data comprises one or more of the following: determining a domain name associated with a supplier of the one or more supplier identifiers, validating a domain name associated with a supplier of the one or more supplier identifiers, comprises matching a supplier with the one or more supplier identifiers with a company in a third-party database, or any other manner of determining profile data.

Interface 202 is also configured to receive an inquiry regarding a supplier. Processor 204 is also configured to query the database (e.g., non-graph database 222) for associate correspondence and associated tags of the supplier and provide a first portion of the associated correspondence and a second portion of the associated tags of the supplier. In some embodiments, the first portion comprises the associated correspondence related to a selected tag. In various embodiments, the selected tag comprises one or more of the following: a predetermined number of most recent contacts with the supplier, a predetermined number of most recent correspondences with the supplier, a predetermined number of most recent topics with the supplier, or any other appropriate tags. In various embodiments, the first portion comprises one or more of the following: a recommendation related to the supplier, a risk related to the supplier, a status related to the supplier, a health related to the supplier, or any other recommendation related to the supplier.

Memory 208 is used for storing data during the execution of task by processor 204.

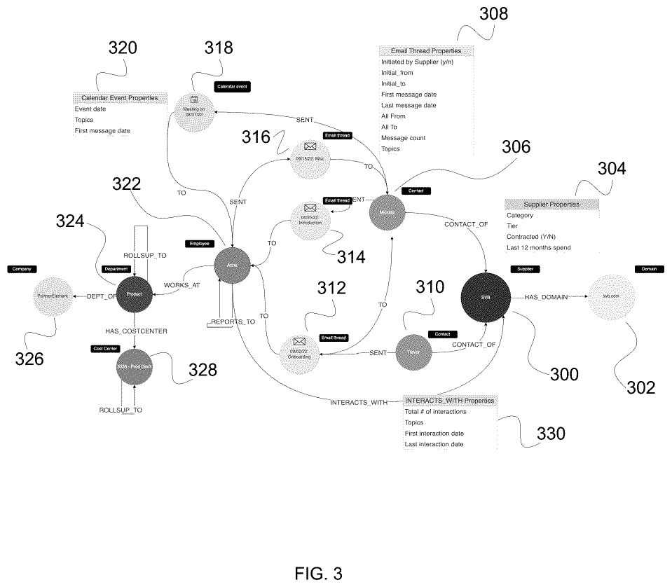

FIG. 3 is a diagram illustrating an embodiment of a graph display for a user. In some embodiments, the graph display of FIG. 3 is provided by supply management service system 106 of FIG. 1 and/or supply management service system 200 FIG. 2 to a user. In the example shown, supplier 300 has domain 302 and supplier properties 304 (e.g., category, tier, contracted status, last 12 months spend, etc.) with supplier contact 306 and supplier contact 310. Supplier contact 306 and supplier contact 310 have email correspondence (e.g., email thread 312, email thread 314, and email thread 316) with organization employee 322. There is a calendar meeting 318 between supplier contact 306 and organization employee 322 with properties 320 (e.g., event date, topics, first message date, etc.). Organization employee 324 works in department 324 with cost center 328 of company 326. Interaction properties 330 between organization employee 322 and supplier 300 are also displayed (e.g., total # of interactions, topics, first interaction date, last interaction date, etc.).

In some embodiments, the links and information related to each graph element are loaded into a graph database automatically upon acquisition from being created and stored in a non-graph database (e.g., in response to identifying information from an email or instant message system or in response to identifying information from querying a third party database related to a supplier name).

In some embodiments, the graph elements are automatically displayed related to a supplier (e.g., including walking all the links from the supplier graph element). In some embodiments, more detail related to a link is displayed when clicked on. In some embodiments, a portion of the graph is displayed (e.g., one or two links away from the element selected or initially queried) and the graph elements can be navigated by scrolling the display to follow links (e.g., those farther from the initial inquiry). In some embodiments, the initial inquiry is related to other elements of the graph (e.g., an employee name, a group, a business unit, or any other graph element).

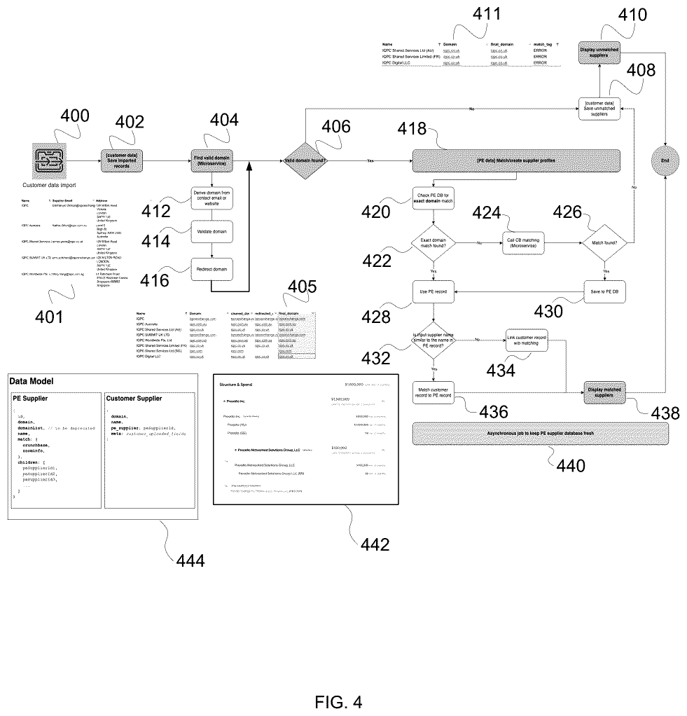

FIG. 4 is a diagram illustrating an embodiment of a flow for importing supplier data. In some embodiments, the flow of Figure is implemented by supplier management service system 106 of FIG. 1 and/or processor 204 of FIG. 2. In the example shown, in 400 customer data is imported. For example, in response to in interaction or query, information is automatically retrieved from one or more of the following: a third party database, an internal database (e.g., a graph database, a non-graph database, etc.), a scraping of email or an instant message (e.g., an email content, an email subject, an email ‘to’ list, an email ‘cc’ list, an email attachment, a message content, a message attachment, a message ‘to’ list, a signature content, a date sent, a date replied, etc.). In some embodiments, contents are filtered for automatically being excluded from a database (e.g., generic emails, messages, on a black list, on a spam list, etc.). In various embodiments, a list of information is generated (e.g., list 401 that includes a company name, a company (e.g., supplier) email address, a physical address, etc.) from automatically extracting an email interaction.

In 402, data (e.g., the customer data, supplier data, etc.) is imported and saved in a database (e.g., a non-graph database, a graph database, etc.). In 404, a valid domain is found. For example, in 412 a domain is derived from a contact email or a website (e.g., detecting and cleaning a domain name), in 414 a domain name is validated (e.g., by comparing to a list of known domain names), in 416 a domain name is redirected, and/or determining a final domain name. For example, sample data 405 shows a list of company names, a set of associated extracted domain names, a set of associated cleaned domain names, a set of associated redirected domain names, a set of associated final domain names.

In 408, it is determined whether a valid domain name has been found. In response to determining that a valid name was not found in 408 data (e.g., customer data, supplier data, etc.) is saved unmatched with a supplier name in a database. In 410, the unmatched supplier data is displayed to a user, and the process ends. For example, list 411 shows a list of information displayed to a user indicating a supplier match was not found (e.g., a company name, a domain name, a final domain name determined, and a match status tag of ERROR).,

In response to a valid domain being found in 406, control passes to 418 in which supplier profiles are matched or created. In 420, the system database(s) (e.g., graph database, non-graph database, etc.) are checked for an exact domain match. In 422, it is determined whether there was an exact match found. In response to an exact match not being found, in 424 a third-party database is queried to determine whether an external match can be found. For example, Crunchbase or ZoomInfo are queried to identify a matching domain name. In 426, it is determined whether an external match is found. In response to no external match being found, control passes to 408 where the data is saved unassociated with a supplier name and a user is informed in 410 that the data was unmatched. In response to an external match being found, in 430 a record is created and the matching domain name is stored in the internal system databases (e.g., the graph and non-graph databases), and control passes to 428. For example, the identified third party database domain name and information from the third party database related to the domain name (e.g., company name, company revenue, company locations, company number of employees, company units, company officers, etc.).

In response to an exact match being found in 422, control passes to 428. In 428, a record identifier (e.g., a domain name) is designated. For example, identifier(s) is/are indicated for locating records in the system databases (e.g., the graph database and the non-graph database). In 432, it is determined whether the input supplier name is similar to the name in the system database associated with the record in the database. In response to the input supplier name not being similar to the name in the system database, in 434 link the customer data with the record and a tag indicating that the name is not an exact match, and control passes to 438. In response to the input supplier name being similar to the name in the system database, in 436 link the customer data with the record and a tag indicating that the name is an exact match, and control passes to 438. In 438, display matched supplier and customer data to a user.

In some embodiments, an asynchronous job is running in the background to keep the system supplier database up to date. For example, periodically or on scanning email or instant messages or upon updates to system databases for internal company records (e.g., spend, contracts, projected spending, etc.), the system refreshes or fetches up to date information for suppliers from third party databases. In some embodiments, data or database information can be displayed or input to the database similar to structure and spend information of 442. In some embodiments, the data model for the system database comprises data model 444.

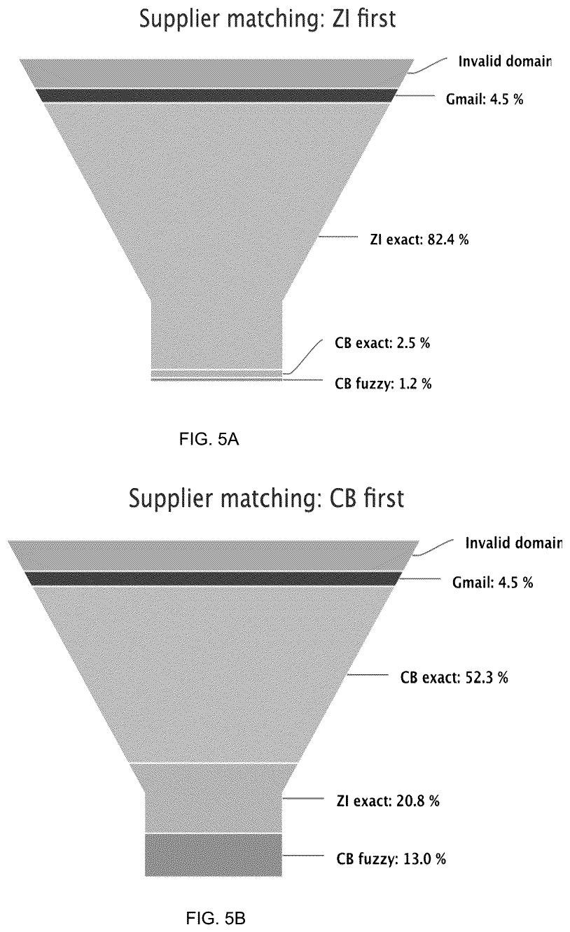

FIGS. 5A and 5B are diagrams illustrating embodiments of supplier matching percentages. In some embodiments, the diagrams of FIGS. 5A and 5B are matching results as in 420 of FIG. 4 or the results from executing a process of third party engine 214 of FIG. 2. In the example shown in FIG. 5A, a matching of a supplier identifier (e.g., a domain name) with a first third party database (e.g., ZoomInfo) first. The initial screening of the domain identifies invalid domain names, 4.5% are matched using gmail, of the remaining 82.4% are matched exactly using a first third party database (e.g., ZoomInfo), of the remaining 2.5% are matched exactly using a second third party database (e.g., Crunchbase), and of the remaining 1.2% are fuzzy matched using the second third party database (e.g., Crunchbase).

In the example shown in FIG. 5B, a matching of a supplier identifier (e.g., a domain name) with a second third party database (e.g., Crunchbase) first. The initial screening of the domain identifies invalid domain names, 4.5% are matched using gmail, of the remaining 52.3% are matched exactly using a second third party database (e.g., Crunchbase), of the remaining 20.8% are matched exactly using a first third party database (e.g., Crunchbase), and of the remaining 1.2% are fuzzy matched using the second third party database (e.g., Crunchbase).

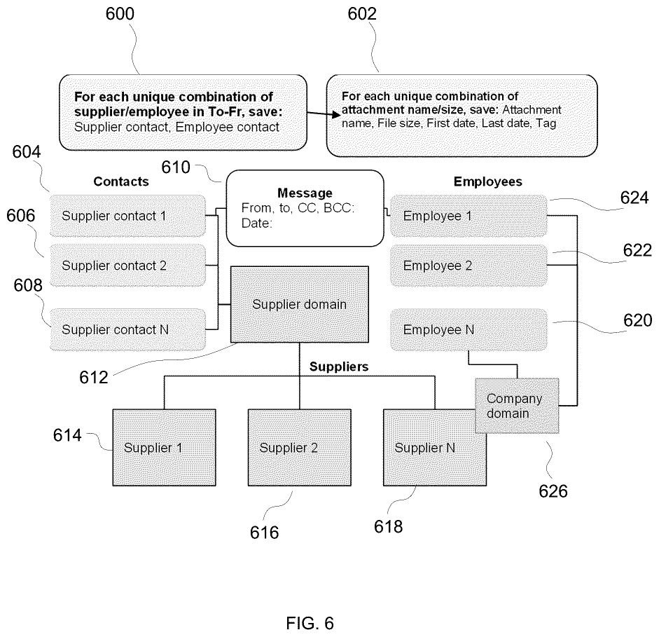

FIG. 6 is a diagram illustrating an embodiment of information to be saved from an email message. In some embodiments, email scanner 210 of FIG. 2 implements a process that identifies and saves the information of FIG. 6 from email messages. In the example shown, at 600 for each unique combination of supplier/employee in To-From email exchange, the system saves supplier contact and employee information into a database (e.g., a non-graph database and a graph database). At 602, for each unique combination of attachment name/size, the system saves an attachment name, a file size, a first date, a last date, and a tag into a database (e.g., a non-graph database and a graph database). In various embodiments, the system saves information extracted from an email message 610 (e.g., message from, message to, cc, bcc, date, etc.)—for example, supplier contact 1 604, supplier contact 2 606, and supplier contact N 608, and related supplier domain 612, which are related to supplier 1 614, supplier 2 616, and supplier N 618, as well as employee 1 624, employee 2 622, and employee N 620 and related company domain 626.

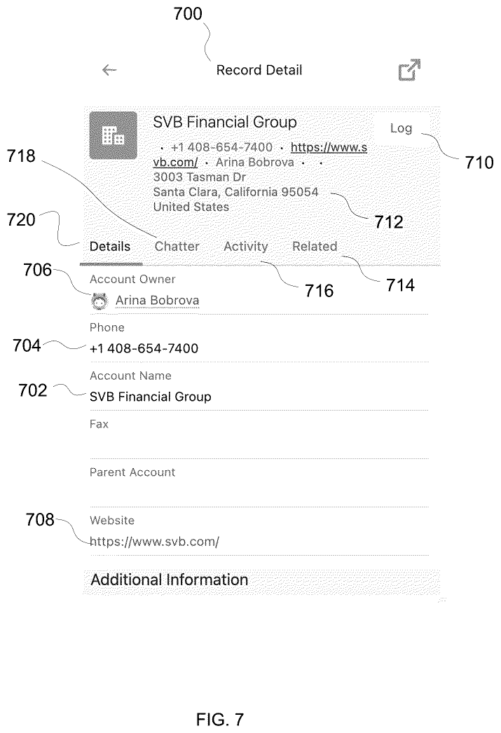

FIG. 7 is a diagram illustrating an embodiment of record detail screen of information. In some embodiments, the user interface display is provided using processor 204 of FIG. 2 of data in storage 206 from a non-graph database 222 and/or graph database 224. In the example shown, record detail screen 700 displays information for details 720—for example account owner 706, phone number 704, account name 702, website name 708, and address 712. A user can select chatter 718 (e.g., emails and/or instant messages or other correspondence related to the record), activity 716 (e.g., purchases, contracts, etc.), related 714 (e.g., related personnel, correspondence, activity, etc.), and log 710 (e.g., a history of activity) to see other related information to the record.

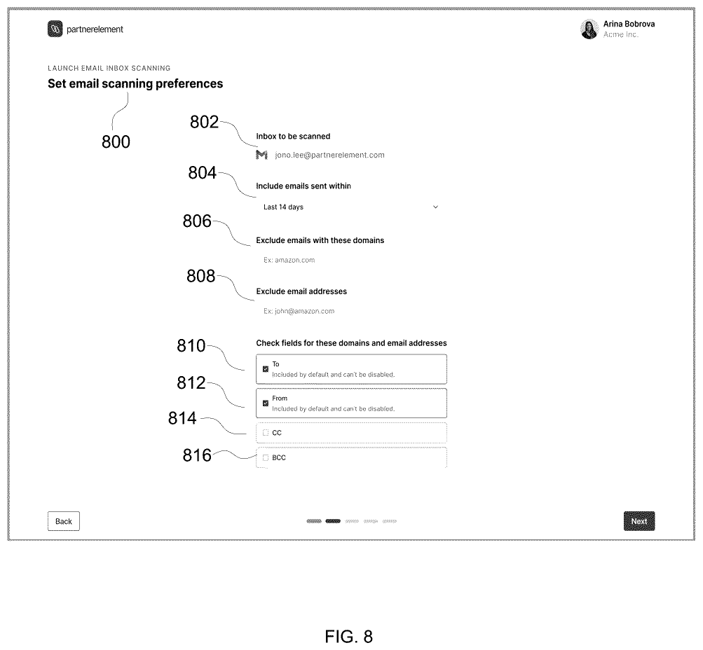

FIG. 8 is a diagram illustrating an embodiment of an email scanning preferences setting user interface display. In some embodiments, the screen is provided by email scanner 210 of FIG. 2 and is used by a user or administrator to set preferences related to scanning emails. In the example shown, interface display 800 is for setting email scanning preferences. Fields enable the setting of parameters—for example, inbox to be scanned 802, time frame 804 for when sent emails are to be included, exclusion domains 806, excluded email addresses 808, check boxes for whether to include a field for checking domains and email addresses (e.g., a “to” field, a “from” field, a “cc” field, a “bcc” field, etc.).

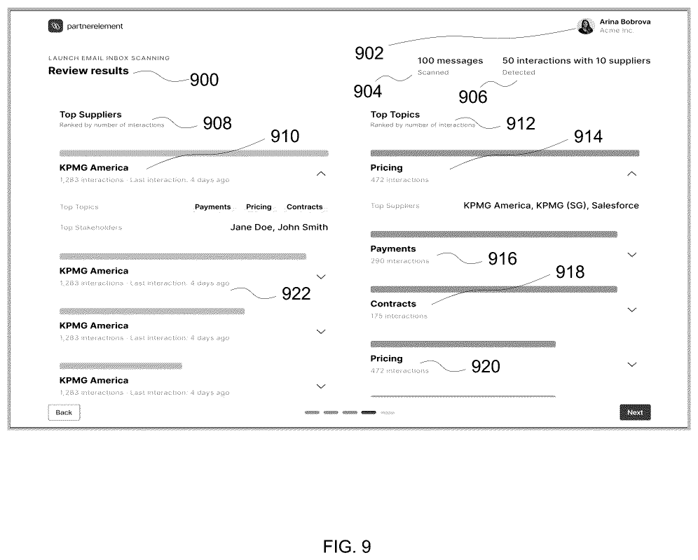

FIG. 9 is a diagram illustrating an embodiment of results review user interface display. In some embodiments, user interface review results 900 is provided for display using processor 204 of FIG. 2. In the example shown, top suppliers 908 and top topics 912 are displayed for employee 902 (e.g., as a user of the system). The user interface displays messages scanned 904 (e.g., a number of messages) and interactions detected (e.g., a number of interactions from a number of suppliers). Top suppliers 908 includes a display of information (e.g., payments, pricing, contracts, stakeholders, etc.) related to a supplier (e.g., supplier 910). Top suppliers 908 also includes other listed entries that are selected to view additional information related to other suppliers 922. Top topics 912 includes a list of topics (e.g., pricing topic 914, payments topic 916, contracts topic 918, pricing topic 920, etc.). Topics in top topics 912 can be selected to display additional information including a number of interactions and top suppliers related to the topic.

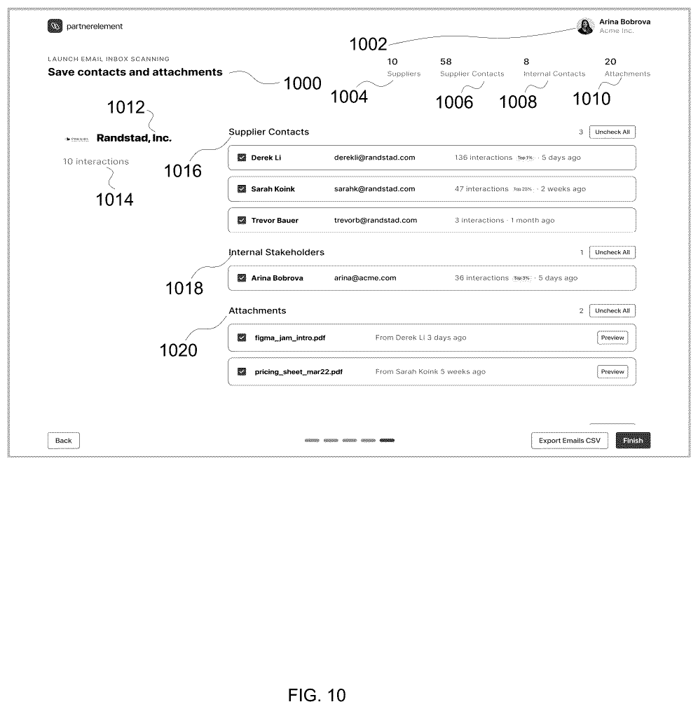

FIG. 10 is a diagram illustrating an embodiment of a content and attachment saving user interface. In some embodiments, user interface save contacts and attachments 1000 is provided for display using processor 204 of FIG. 2. In the example shown, save contacts and attachments 1000 is a user interface display displaying user 1002, number of suppliers 1004, number of supplier contacts 1006, number of internal contacts 1008, and number of attachments 1010. Save contacts and attachments 1000 is a user interface display further displaying a supplier company 1012 and a number of interactions with the supplier company 1014. Supplier contacts 1016 are displayed (e.g., contact name, contact email address, number of interactions, ranking (e.g., top 7%), a time of last interaction, etc.) with a check box to indicate whether the contact should be scanned. There is also an option to uncheck all supplier contacts from scanning. Internal stakeholders 1018 are displayed (e.g., contact name, contact email address, number of interactions, ranking (e.g., top 7%), a time of last interaction, etc.) with a check box to indicate whether the internal stakeholder emails should be scanned. There is also an option to uncheck all internal stakeholder emails from scanning. Attachments 1020 are displayed (e.g., file name, from whom the file was received, time or date received, etc.) with a check box to indicate whether the attachment should be scanned. There is also an option to uncheck all internal stakeholder emails from scanning. In addition, there is a button to export the user display information to a csv.

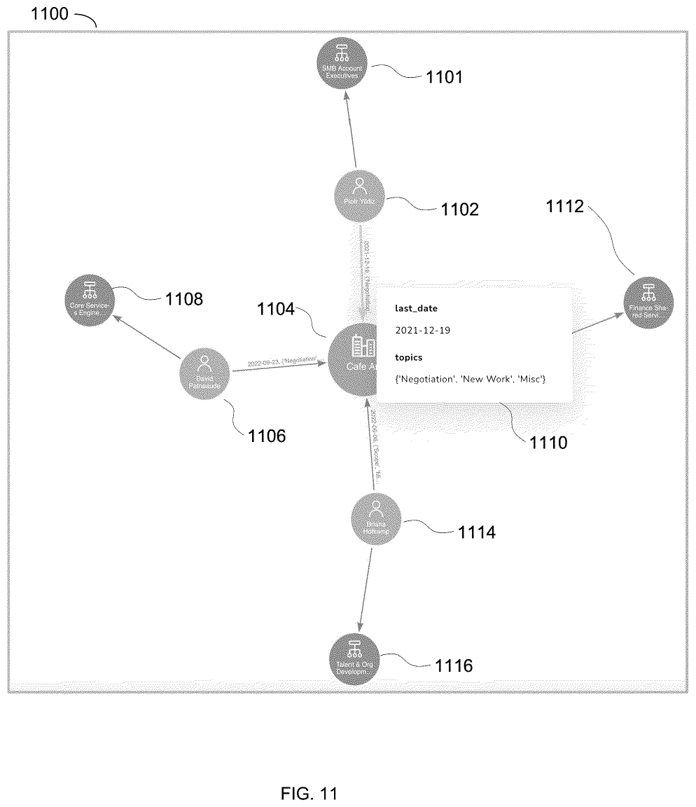

FIG. 11 is a diagram illustrating an embodiment of a user interface display depicting who is connected to supplier Café Art. In some embodiments, user interface save supplier connections graph in FIG. 11 is provided for display using processor 204 of FIG. 2. In the example shown, supplier connections graph 1100 shows connections to supplier 1104 (e.g., supplier Café Art). Supplier connections graph 1100 shows unit 1101 (e.g., associated with unit SMB Account Executives) connected to contact 1102 (e.g., Pietr Yildiz) with relation (e.g., in a status of “negotiation” as of a date ‘2021-12-19’) with supplier 1104. Supplier connections graph 1100 shows unit 1108 (e.g., associated with unit core services engineering) connected to contact 1106 (e.g., David Patneaude) and relation (e.g., in a status of ‘negotiation’ as of a date ‘2022-09-23’) with supplier 1104. Supplier connections graph 1100 shows unit 1116 (e.g., associated with Talent and Organization unit) connected to contact 1114 (e.g., Briana Hofkamp) and relation (e.g., in a status of ‘scope’ as of a date ‘2022-06-06’) with supplier 1104. Supplier connections graph 1100 shows unit 1112 (e.g., associated with Finance Shared Services unit) connected to contact a contact obscured by detail display 1110 which shows a last date of contact and topics of interaction (e.g., ‘Negotiation’, ‘New Work’, and ‘Misc’).

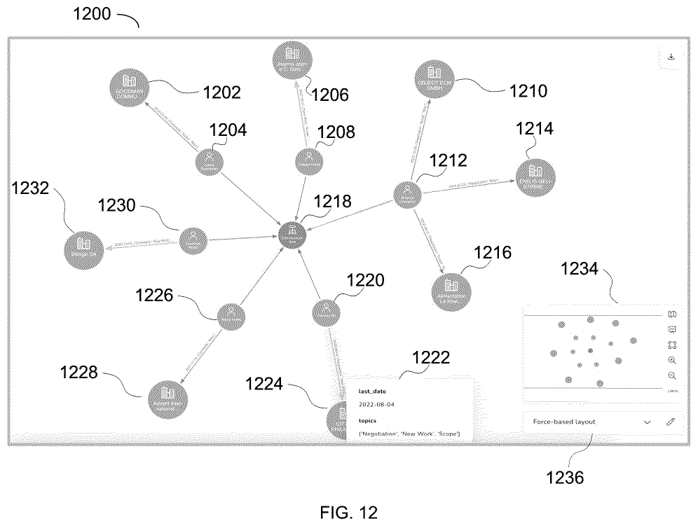

FIG. 12 is a diagram illustrating an embodiment of a user interface display depicting who is connected to an organization unit. In some embodiments, user interface organization unit connections graph 1200 in FIG. 12 is provided for display using processor 204 of FIG. 2. In the example shown, organization unit connections graph 1200 shows connections of organization unit 1218 (e.g., ‘Communications’). Organization unit connections graph 1200 displays indications that organization unit 1218 has connection to personnel 1204 (e.g., ‘Laura Boardman’) who is in communication with supplier 1202 with information (e.g., last date of contact (e.g., ‘2022-03-24’) and topics (e.g., ‘Contracts’, ‘Scope’, ‘Misc’)) related to contact with supplier 1202 (e.g., ‘Goodman Communications’). Organization unit connections graph 1200 displays indications that organization unit 1218 has connection to personnel 1208 (e.g., ‘Fabian Priest’) who is in communication with supplier 1206 with information (e.g., last date of contact (e.g., ‘2022-10-27’) and topics (e.g., ‘New Work’, ‘Scope’, . . . )) related to contact with supplier 1206 (e.g., ‘Joanna Jayne C. Gels . . . ). Organization unit connections graph 1200 displays indications that organization unit 1218 has connection to personnel 1212 (e.g., ‘Briana Crompton’) who is in communication with supplier 1210 (e.g., ‘Object ECM GMBH’) with information (e.g., last date of contact (e.g., ‘2022-10-29’) and topics (e.g., ‘Negotiation, ‘Scope’, ‘Misc’)) related to contact with supplier 1210; who is also in communication with supplier 1214 (e.g., ‘ENG IS GELISTIRME . . . ’) with information (e.g., last date of contact (e.g., ‘2022-03-20’) and topics (e.g., ‘Negotiation, ‘Misc’)) related to contact with supplier 1214; who is also in communication with supplier 1216 (e.g., ‘Alimentation La Khai . . . ’) with information (e.g., last date of contact (e.g., ‘2022-09-01’) and topics (e.g., ‘Negotiation, ‘Scope’, ‘Misc’)) related to contact with supplier 1216. Organization unit connections graph 1200 displays indications that organization unit 1218 has connection to personnel 1220 (e.g., ‘Thomas Ali’) who is in communication with supplier 1224 with information (e.g., last date of contact (e.g., ‘2022-08-04’) and topics (e.g., ‘Negotiation’, ‘New Work’, ‘Scope’)) related to contact with supplier 1224 (e.g., ‘City of Philadelphia’). Detail pop up 1222 shows last date and topic information when the link between personnel 1220 or personnel 1220 or supplier 1224 are selected (e.g., double clicked on). Organization unit connections graph 1200 displays indications that organization unit 1218 has connection to personnel 1226 (e.g., ‘Maria Hsieh’) who is in communication with supplier 1226 with information (e.g., last date of contact (e.g., ‘2021-11-14’) and topics (e.g., ‘Contracts’, ‘Misc’)) related to contact with supplier 1228 (e.g., ‘Advent International . . . ’). Organization unit connections graph 1200 displays indications that organization unit 1218 has connection to personnel 1230 (e.g., ‘Courtney Bedel’) who is in communication with supplier 1232 with information (e.g., last date of contact (e.g., ‘2022-10-05’) and topics (e.g., ‘Contracts’, ‘New Work’)) related to contact with supplier 1232 (e.g., ‘Bitlogic SA’).

In some embodiments, organization unit connections graph 1200 shows display control 1234 and pull down menu 1236.

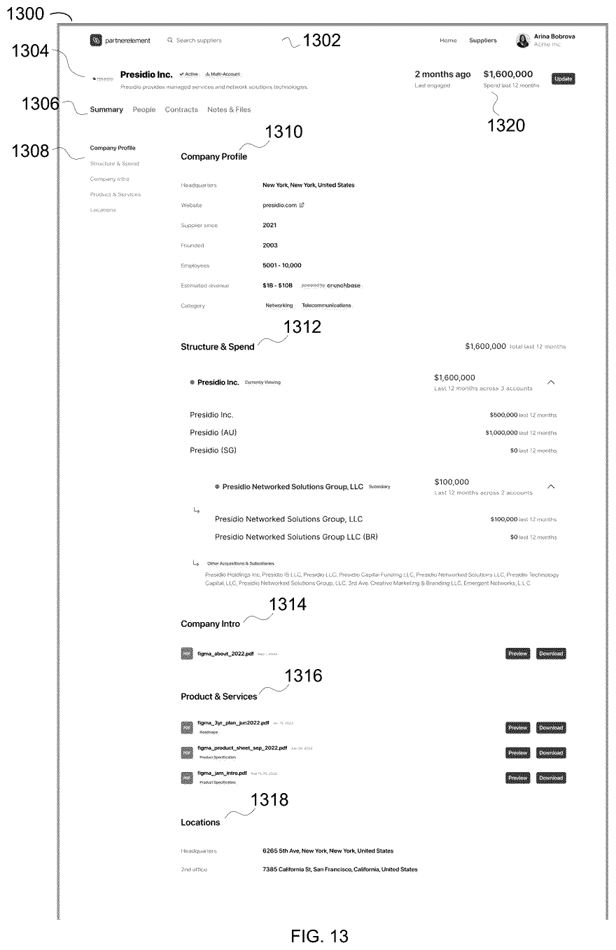

FIG. 13 is a diagram illustrating an embodiment of a user interface display depicting supplier information. In some embodiments, user interface depicting supplier information 1300 in FIG. 13 is provided for display using processor 204 of FIG. 2. In the example shown, user interface depicting supplier information 1300 shows supplier name and status 1304 (e.g., name and short summary as well as a button showing ‘active status’ as well as a button showing ‘multi-account status’). User interface depicting supplier information 1300 shows button tabs 1306 (e.g., ‘Summary’, ‘People’, ‘Contracts’, and ‘Notes & Files’). User interface depicting supplier information 1300 shows summary tab sub-tabs 1308 (e.g., ‘Company Profile’, ‘Structure & Spend’, ‘Company Intro’, ‘Product & Service’, and ‘Locations’). User interface depicting supplier information 1300 shows company profile frame 1310 (e.g., ‘Headquarters’, ‘Website’, ‘Supplier since’, ‘Founded’, ‘Employees’, ‘Estimated revenue’ and a source button—for example, Crunchbase, and ‘Category’ and buttons for categories—for example, networking and telecommunications). User interface depicting supplier information 1300 shows structure & spend frame 1312 (e.g., ‘Last 12-month spend’, ‘Business unit breakdown’, ‘Subsidiary’, etc.). User interface depicting supplier information 1300 shows company intro frame 1314 (e.g., files showing company intro that can be previewed or downloaded with interface buttons). User interface depicting supplier information 1300 shows product & service frame 1316 (e.g., files showing company intro that can be previewed or downloaded with interface buttons). User interface depicting supplier information 1300 shows locations frame 1318 (e.g., headquarters address, 2nd office address, etc.). User interface depicting supplier information 1300 shows last engaged time with supplier and total last 12-month spend 1320.

In some embodiments, user interface depicting supplier information 1300 displays an update button that enables a user to update the status of the supplier. In some embodiments, user interface depicting supplier information 1300 displays a search bar 1302 that enables a user to search the system database for a supplier.

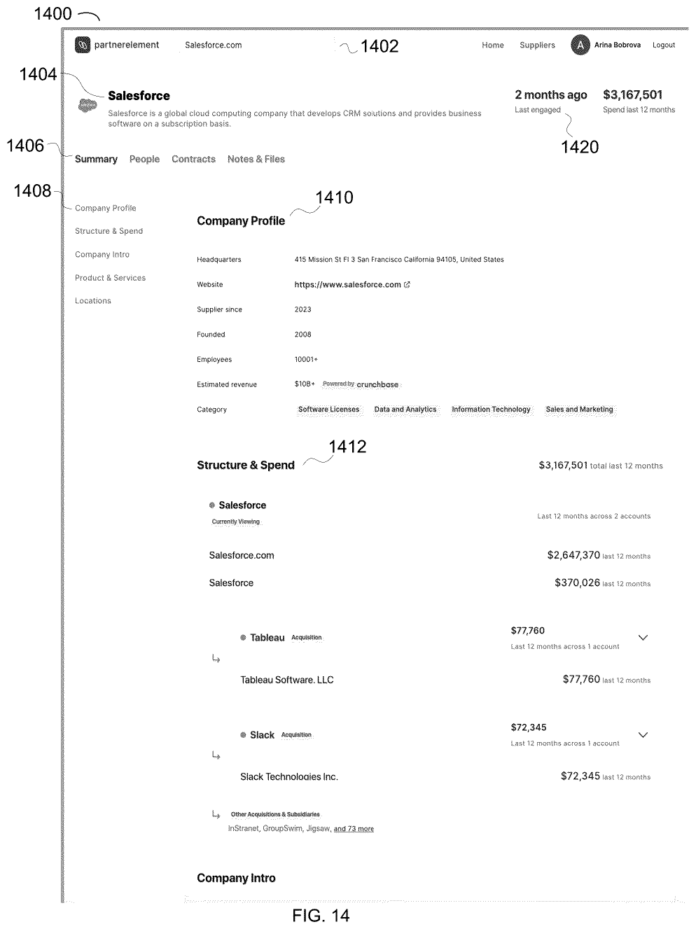

FIG. 14 is a diagram illustrating an embodiment of a user interface display depicting supplier information. In some embodiments, user interface depicting supplier information 1400 in FIG. 14 is provided for display using processor 204 of FIG. 2. In the example shown, user interface depicting supplier information 1400 shows supplier name and status 1404 (e.g., name and short summary). User interface depicting supplier information 1400 shows button tabs 1406 (e.g., ‘Summary’, ‘People’, ‘Contracts’, and ‘Notes & Files’). User interface depicting supplier information 1400 shows summary tab sub-tabs 1408 (e.g., ‘Company Profile’, ‘Structure & Spend’, ‘Company Intro’, ‘Product & Service’, and ‘Locations’). User interface depicting supplier information 1400 shows company profile frame 1410 (e.g., ‘Headquarters’, ‘Website’, ‘Supplier since’, ‘Founded’, ‘Employees’, ‘Estimated revenue’ and a source button—for example, Crunchbase, and ‘Category’ and buttons for categories—for example, software licenses, data and analytics, information technology, sales and marketing). User interface depicting supplier information 1300 shows structure & spend frame 1412 (e.g., ‘Last 12-month spend’, ‘Business unit breakdown’, ‘Subsidiary’, ‘Acquisition’, etc.). User interface depicting supplier information 1400 shows last engaged time with supplier and total last 12-month spend 1420.

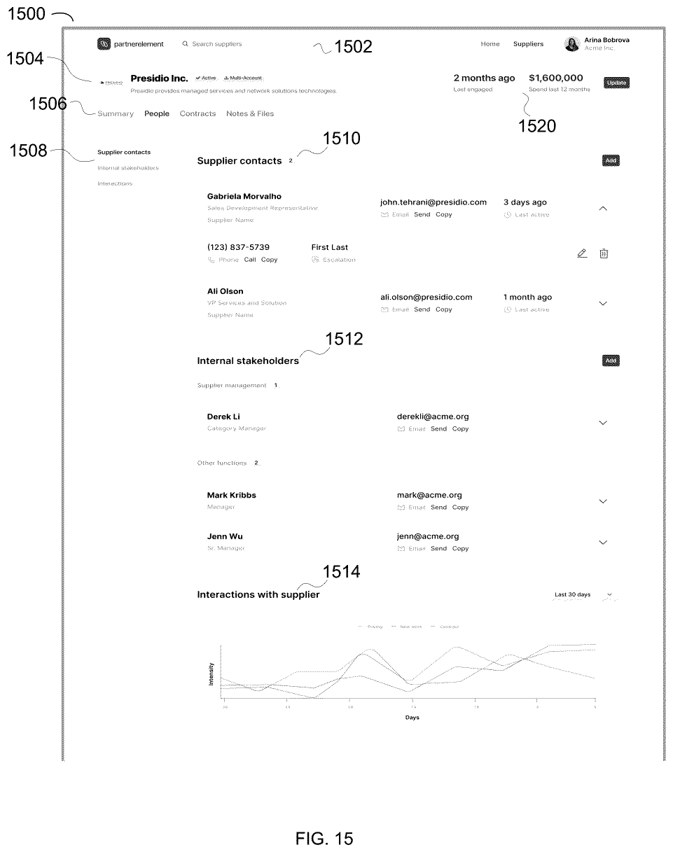

FIG. 15 is a diagram illustrating an embodiment of a user interface display depicting supplier information. In some embodiments, user interface depicting supplier information 1500 in FIG. 15 is provided for display using processor 204 of FIG. 2. In the example shown, user interface depicting supplier information 1500 shows supplier name and status 1504 (e.g., name and short summary). User interface depicting supplier information 1500 shows button tabs 1506 (e.g., ‘Summary’, ‘People’, ‘Contracts’, and ‘Notes & Files’). User interface depicting supplier information 1500 shows People tab sub-tabs 1508 (e.g., ‘supplier contact’, ‘internal stakeholders’, and ‘interactions’). User interface depicting supplier information 1500 shows supplier contact frame 1510 (e.g., ‘contact name’, ‘contact title’, ‘email address’, ‘phone number’, ‘escalation name’ for each contact). User interface depicting supplier information 1500 shows internal stakeholders frame 1512 (e.g., ‘personnel name’, ‘personnel title’, ‘email address’, etc.). User interface depicting supplier information 1500 shows interactions with supplier graphs 1514 (e.g., a graph depicting intensity of interactions related to pricing, new work, and contracts). User interface depicting supplier information 1500 shows last engaged time with supplier and total last 12-month spend 1520.

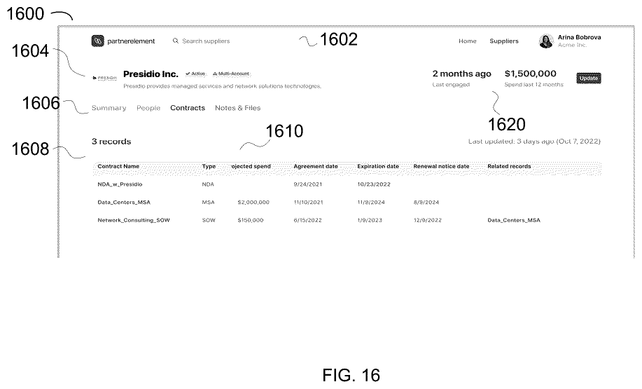

FIG. 16 is a diagram illustrating an embodiment of a user interface display depicting supplier information. In some embodiments, user interface depicting supplier information 1600 in FIG. 16 is provided for display using processor 204 of FIG. 2. In the example shown, user interface depicting supplier information 1600 shows supplier name and status 1604 (e.g., name and short summary including active and multi-account buttons). User interface depicting supplier information 1600 shows button tabs 1606 (e.g., ‘Summary’, ‘People’, ‘Contracts’, and ‘Notes & Files’). User interface depicting supplier information 1600 shows Contracts records 1608 (e.g., ‘contract name’, ‘type’, ‘projected spend’, ‘agreement date’, ‘expiration date’, ‘renewal notice date’, ‘related records’, etc.). User interface depicting supplier information 1600 shows last engaged time with supplier and total last 12-month spend 1620.

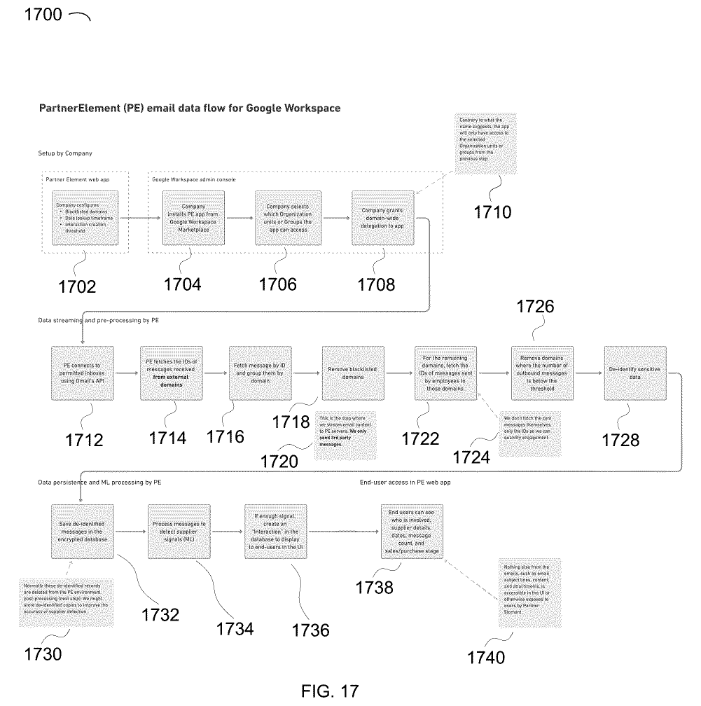

FIG. 17 is a diagram illustrating an embodiment of an email data processing flow. In some embodiments, the processing flow of FIG. 17 comprises system processing for emails including processing using processor 204 of FIG. 2. In the example shown, in 1702, client sets up system web app. For example the client company configures blacklisted domains, data lookup timeframes (e.g., within the last 180 days, since 5/19/23, etc.), and interaction creation thresholds (e.g., minimum confidence score, number of unique emails involved, number of outbound emails, etc.). In 1704, the client company installs the system app from a site (e.g., Google Workspace Martketplace). In 1706, the client company selects which organization units or groups the app can access. For example, personnel, business units, groups, teams, individuals, can be selected for being accessed by the system or not being access by the system. In 1708, the client company grans domain-wide delegation to the system application. Note 1710 indicates that the application will only have access to the selected organization units, groups, teams, personnel, individuals, business units, or other specified people or groups of people as selected in 1706. In 1712, the system connects to permitted inboxes using an email API (e.g., gmail's API). In 1714, the system fetches the IDs of messages received from external domains. In 1716, the system fetches messages by IDs and groups them by domain. In 1718, emails associated with blacklisted domains are removed. For example, note 1720 indicates that only emails from acceptable domains are candidates for system input. In 1722, email messages (e.g., by employees to the acceptable domains) associated with IDs of messages for acceptable domains are sent to the system. In some embodiments, the sent messages are not fetched only the IDs for the messages so that the engagement is quantifiable. In 1726, domains are removed where the number of outbound messages is below a threshold. In 1728, the system de-identifies sensitive data. In 1732, deidentified messages are saved in the database. In some embodiments, deidentified records are deleted from the system. In some embodiments, deidentified copies are stored to improve processing accuracy. In 1734, messages are processed to detect supplier signals. In some embodiments, processing includes using a machine learning model (ML). In 1736, if enough signal, an interaction is created in the database to display to end-users in the user interface. In 1738, an end user can see who is involved supplier details, dates, message counts, and sales/purchase stage. Note 1740 indicates that nothing else from the email is accessible including subject lines, content, and attachments.

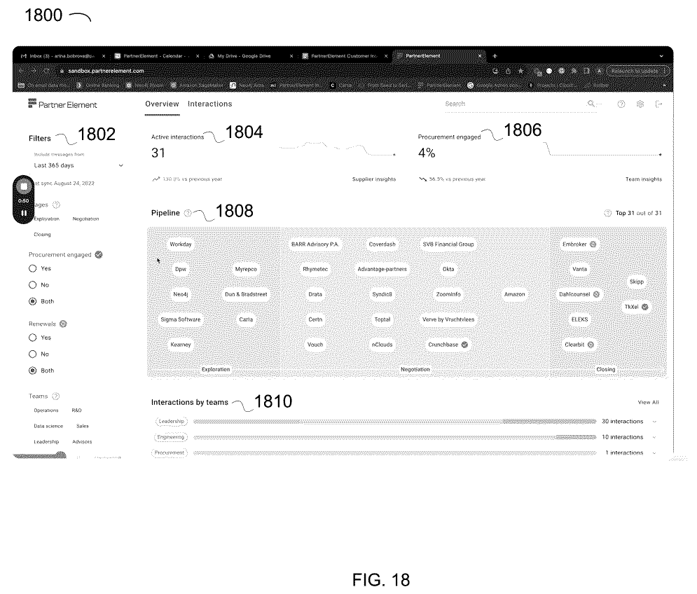

FIG. 18 is a diagram illustrating an embodiment of a user interface displaying a dashboard. In some embodiments, the user interface of FIG. 18 is provided for display using processor 204 of FIG. 2. In the example shown, dashboard display 1800 shows filters frame 1802, active interactions frame 1804, procurement engaged frame 1806, pipeline frame 1808, and interactions by teams frame 1810. Filters frame 1802 includes message from pull down menu, stages (e.g., exploration, negotiation, closing, etc.), procurement engaged selection buttons (e.g., yes, no, and both), renewals selection buttons (e.g., yes, no, and both), and teams listing (e.g., operations, R&D, data science, sales, leadership, and advisors). Active interactions frame 1804 displays a number of interactions, a graph of interactions over time, percentage increase/decrease vs. previous year, and a button to see supplier insights. Procurement engaged frame 1806 displays a percentage procurement personnel, a graph of engagement over time, percentage increase/decrease vs previous year, and a button to see team insights. Pipeline frame 1808 includes supplier company names in an exploration stage, supplier company names in a negotiation stage, supplier company names in a closing stage, a top number of suppliers out of a total number of suppliers. Interactions by teams frame 1810 includes a break down of stages for a number of interactions in each stage for leadership team, for engineering team, for procurement team.

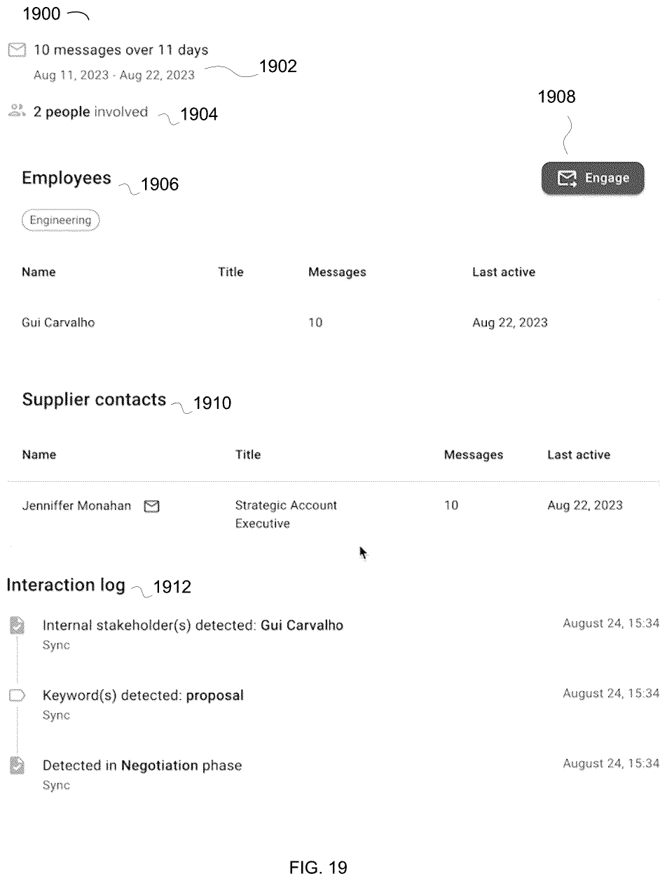

FIG. 19 is a diagram illustrating an embodiment of a user interface displaying supplier contacts. In some embodiments, the user interface of FIG. 19 is provided for display using processor 204 of FIG. 2. In the example shown, supplier contact interface 1900 includes a number of messages over a number of days and the first date and last date of the messages. Contacts involved 1904 indicate the number of personnel involved in interactions with the supplier. Supplier contact interface 1900 includes engagement button 1908 that enables a user to send an email or message to the supplier. In various embodiments, the system automatically provides a contact email address, a list of prior supplier contact email addresses, a contact instant messaging number, a list of prior supplier contact instant messaging identifiers, or any other related contact information. Supplier contact interface 1900 includes employees portion 1906 that shows business unit and employee name, employee title, number of messages, and last active date. Supplier contact interface 1900 includes supplier contacts portion 1910 that shows supplier contact name, supplier contact title, number of messages, and last active date. Supplier contact interface 1900 includes interaction log portion 1912 that shows a log of date and times of the system detection of a stakeholder, a keyword, an interaction phase, etc.

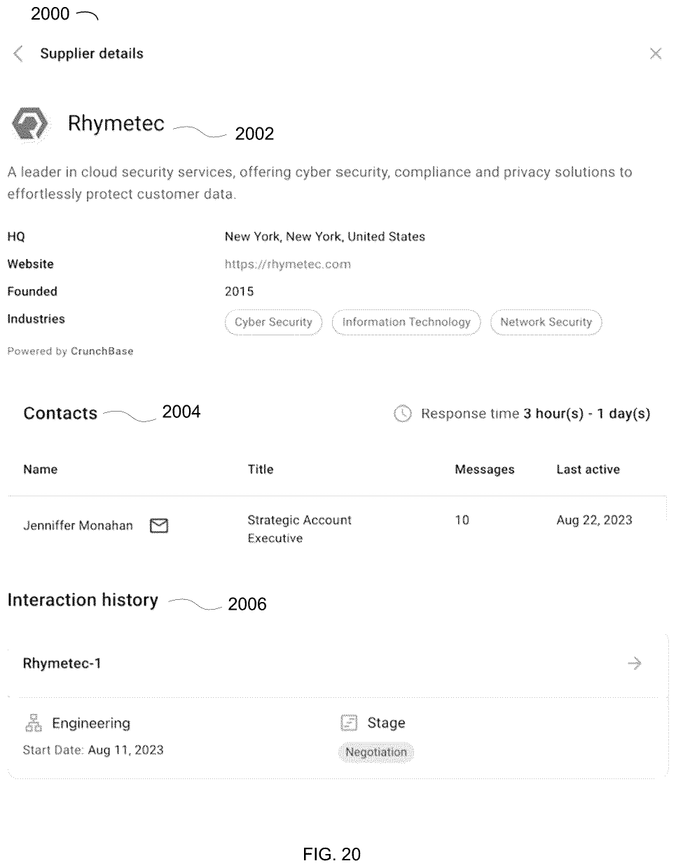

FIG. 20 is a diagram illustrating an embodiment of a user interface displaying supplier details. In some embodiments, the user interface of FIG. 20 is provided for display using processor 204 of FIG. 2. In the example shown, supplier details interface 2000 includes supplier information 2002 (e.g., headquarter location, a website, a founding date, related industries, third party information source, etc.). Supplier details interface 2000 includes supplier contact information 2004 (e.g., a supplier contact name, a supplier contact title, a supplier contact number of messages, a supplier contact last active date, a supplier contact response time range, etc.). Supplier details interface 2000 includes interaction history information 2006 (e.g., supplier business unit, stage of interaction, start date, etc.).

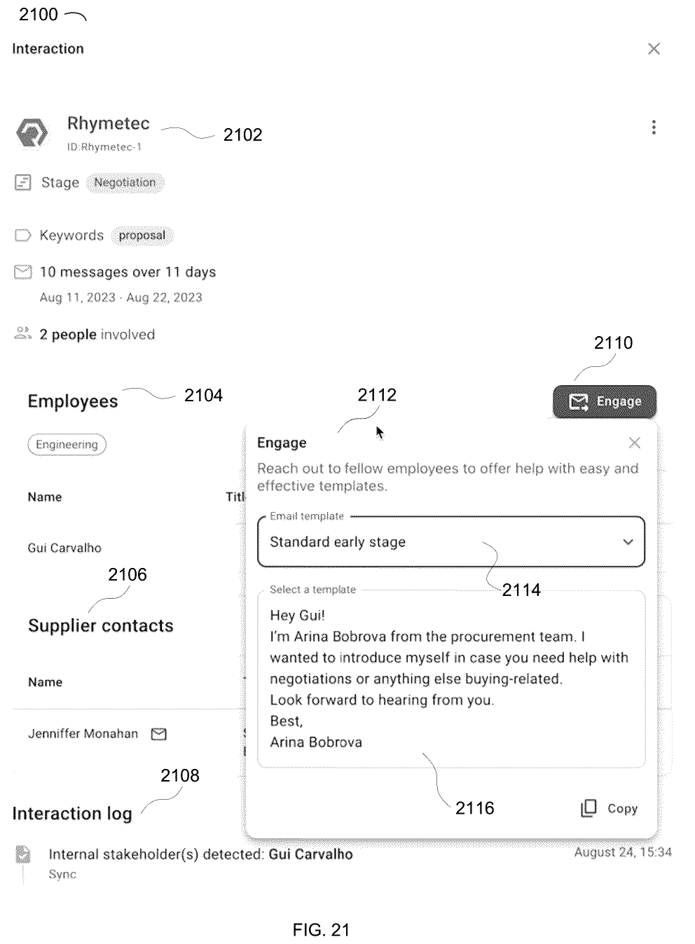

FIG. 21 is a diagram illustrating an embodiment of a user interface displaying supplier contacts. In some embodiments, the user interface of FIG. 21 is similar to the user interface of FIG. 19. In some embodiments, the user interface of FIG. 21 is provided for display using processor 204 of FIG. 2. In the example shown, supplier contact interface 2100 includes a number of messages over a number of days and the first date and last date of the messages, stage of interaction, keywords, number of people involved in the interaction, an identifier, etc. Supplier contact interface 2100 includes engagement button 2110 that enables a user to send an email or message to the supplier. Engagement frame 2112 is provided to the user upon activating engagement button 2110 and the display in engagement frame 2112 includes a selectable menu for email template 2114 and editable email text 2116. In some embodiments, engagement frame 2112 provides a user with selectable instant messaging templates. In various embodiments, the system automatically provides a contact email address, a list of prior supplier contact email addresses, a contact instant messaging number, a list of prior supplier contact instant messaging identifiers, or any other related contact information. Supplier contact interface 2100 includes employees portion 2106 that shows business unit and employee name, employee title, number of messages, and last active date. Supplier contact interface 2100 includes supplier contacts portion 2106 that shows supplier contact name, supplier contact title, number of messages, and last active date. Supplier contact interface 2100 includes interaction log portion 2108 that shows a log of date and times of the system detection of a stakeholder, a keyword, an interaction phase, etc.

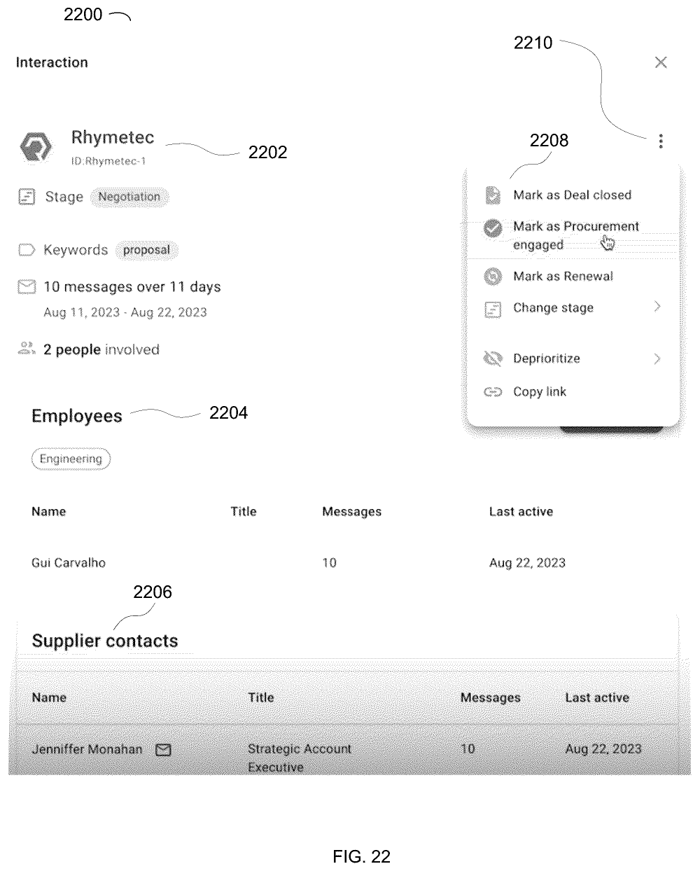

FIG. 22 is a diagram illustrating an embodiment of a user interface displaying supplier contacts. In some embodiments, the user interface of FIG. 22 is similar to the user interface of FIG. 19. In some embodiments, the user interface of FIG. 22 is provided for display using processor 204 of FIG. 2. In the example shown, supplier contact interface 2200 includes a number of messages over a number of days and the first date and last date of the messages, stage of interaction, keywords, number of people involved in the interaction, an identifier, etc. Supplier contact interface 2200 includes action menu 2208 that enables a user to send an email or message to the supplier. Action menu 2208 is provided to the user upon activating menu button 2210 and the display in action menu 2208 includes a selectable menu. In various embodiments, action menu 2208 includes a mark deal as closed menu item, a mark as procurement engaged menu item, a mark as renewal menu item, a change stage selection menu item (e.g., including Exploration, Negotiation, Closing sub selections), a deprioritize selection menu item (e.g., including Irrelevant for Procurement, Not a Supplier, Low Priority, and Other sub selections), a copy link menu item, or any other appropriate menu selection or item. Supplier contact interface 2200 includes employees portion 2204 that shows business unit and employee name, employee title, number of messages, and last active date. Supplier contact interface 2200 includes supplier contacts portion 2206 that shows supplier contact name, supplier contact title, number of messages, and last active date.

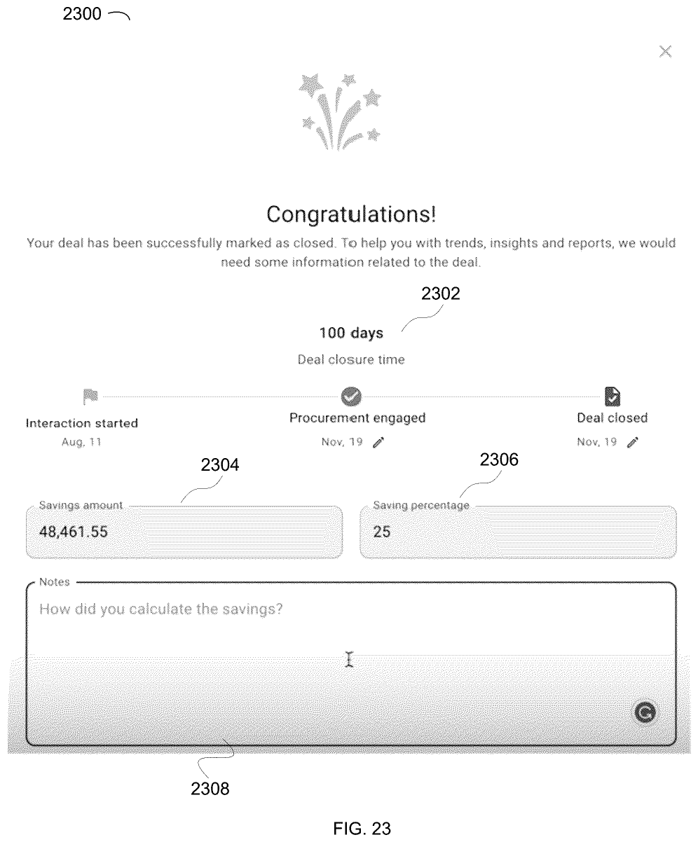

FIG. 23 is a diagram illustrating an embodiment of a user interface displaying a deal closing. In some embodiments, the user interface of FIG. 23 is provided for display using processor 204 of FIG. 2. In the example shown, deal closing display 2300 includes an indication of congratulations with a number of days for deal closure 2302 and a date for interaction start, a date for procurement engagement, a date for deal closing. Dead closing display 2300 further includes savings amount display 2304 and percentage savings display 2306 as well as notes 2308 to explain savings calculation.

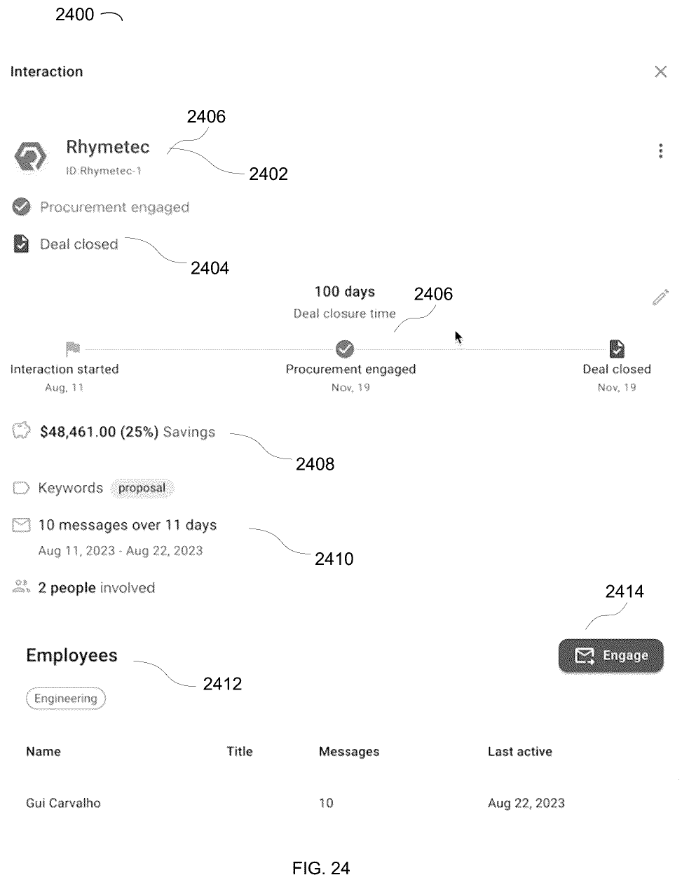

FIG. 24 is a diagram illustrating an embodiment of a user interface displaying a summary for procurement engagement. In some embodiments, the user interface of FIG. 24 is provided for display using processor 204 of FIG. 2. In the example shown, summary procurement engagement display 2400 includes company name 2402 that was engaged with as well as deal status 2404. Procurement engagement display 2400 further includes dates and timeline for the deal closure (e.g., interaction start date, engagement date, deal closing date, etc.). Procurement engagement display 2400 also includes savings amount 2408, associated information 2410 (e.g., keywords associated—such as proposal, number of messages and time period and dates over which the messages were received, number of people involved, etc.). Procurement engagement display 2400 further includes employees 2412 involved in the engagement (e.g., the group of the employees and the name, title, number of messages, and last active date). Procurement engagement display 2400 also includes engagement button 2414 that enables initiating an engagement connection.

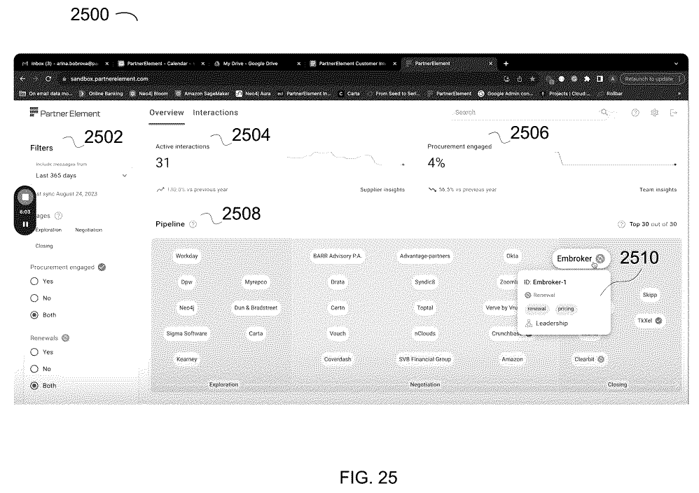

FIG. 25 is a diagram illustrating an embodiment of a user interface displaying a dashboard. In some embodiments, the user interface of FIG. 25 is provided for display using processor 204 of FIG. 2. In the example shown, dashboard display 2500 shows filters frame 2502, active interactions frame 2504, procurement engaged frame 2506, and pipeline frame 2508. Filters frame 2502 includes message from pull down menu, stages (e.g., exploration, negotiation, closing, etc.), procurement engaged selection buttons (e.g., yes, no, and both) and renewals selection buttons (e.g., yes, no, and both). Active interactions frame 2504 displays a number of interactions, a graph of interactions over time, percentage increase/decrease vs. previous year, and a button to see supplier insights. Procurement engaged frame 2506 displays a percentage procurement personnel, a graph of engagement over time, percentage increase/decrease vs previous year, and a button to see team insights. Pipeline frame 2508 includes supplier company names in an exploration stage, supplier company names in a negotiation stage, supplier company names in a closing stage, a top number of suppliers out of a total number of suppliers. Dashboard display 2500 shows pipeline company detail frame 2510 that includes a company name, an engagement state, an engagement topic, a group interacting with the supply company.

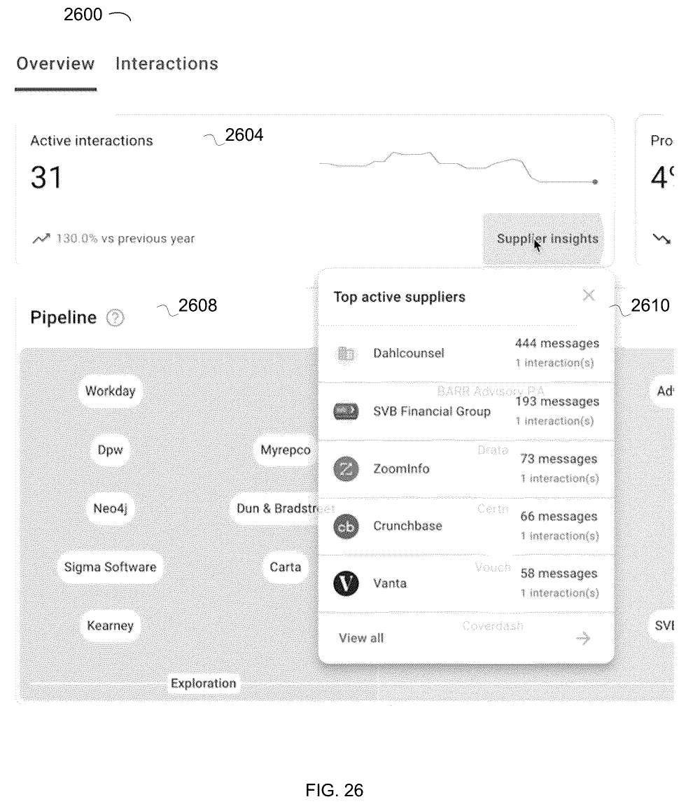

FIG. 26 is a diagram illustrating an embodiment of a user interface displaying a dashboard. In some embodiments, the user interface of FIG. 26 is provided for display using processor 204 of FIG. 2. In the example shown, dashboard display 2600 shows active interactions frame 2604 and pipeline frame 2608. Active interactions frame 2604 displays a number of interactions, a graph of interactions over time, percentage increase/decrease vs. previous year, and a button to see supplier insights. Pipeline frame 2608 includes supplier company names in an exploration stage, supplier company names in a negotiation stage, supplier company names in a closing stage, a top number of supplier out of a total number of suppliers. Dashboard display 2600 shows top active suppliers detail frame 2610 that includes supplier company names, number of interactions, and a number of messages with each supplier company.

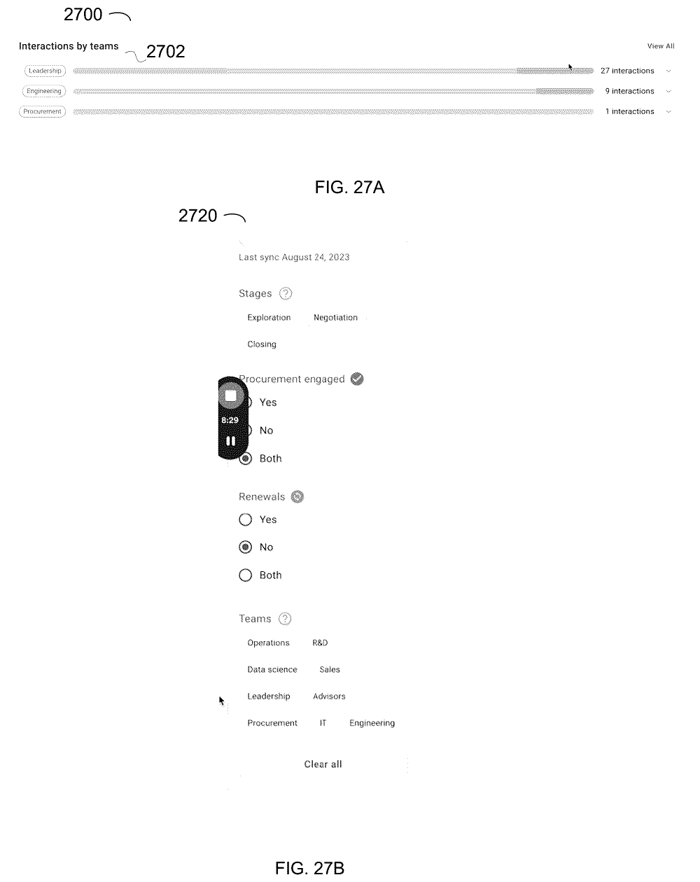

FIG. 27A is a diagram illustrating an embodiment of a user interface displaying an interactions by team frame. In some embodiments, the user interface of FIG. 27A is provided for display using processor 204 of FIG. 2. In some embodiments, interactions by team frame is displayed as part of a dashboard. In the example shown, interactions by team frame 2700 shows a team name and the engagement phases for the interactions and a number of interactions.

FIG. 27B is a diagram illustrating an embodiment of a user interface displaying a dashboard. In some embodiments, the user interface of FIG. 27B is provided for display using processor 204 of FIG. 2. In the example shown, dashboard display shows filters frame 2720. Filters frame 2720 includes message from pull down menu, stages (e.g., exploration, negotiation, closing, etc.), procurement engaged selection buttons (e.g., yes, no, and both), renewals selection buttons (e.g., yes, no, and both), and teams listing (e.g., operations, R&D, data science, sales, leadership, procurement, IT, Engineering, and advisors). Filters frame 2720 further includes a clear all button for clearing all filters selected.

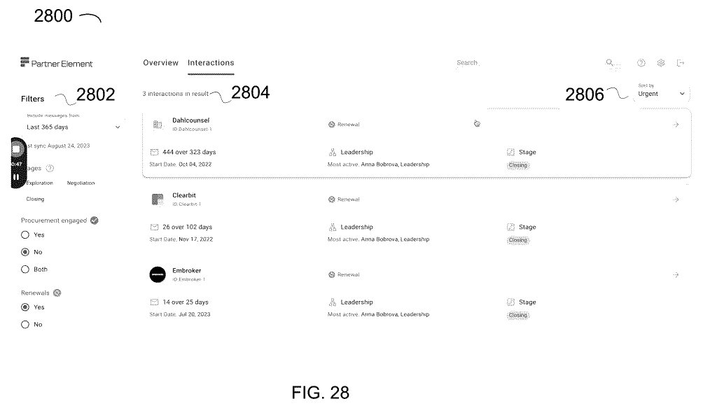

FIG. 28 is a diagram illustrating an embodiment of a user interface displaying a dashboard. In some embodiments, the user interface of FIG. 28 is provided for display using processor 204 of FIG. 2. In the example shown, dashboard display shows filters frame 2802. Filters frame 2800 includes message from pull down menu, stages (e.g., exploration, negotiation, closing, etc.), procurement engaged selection buttons (e.g., yes, no, and both), and renewals selection buttons (e.g., yes, no, and both). Dashboard display shows interactions 2804 including supplier company name engagement phase, interaction number over a time period (e.g., 444 interactions over 323 days with a start date of Oct. 4, 2022), team and team member with most activity, and stage of engagement (e.g., closing). Dashboard display includes sort menu selector 2806 for selecting display sort criteria for interactions 2804 (e.g., urgent, etc.).

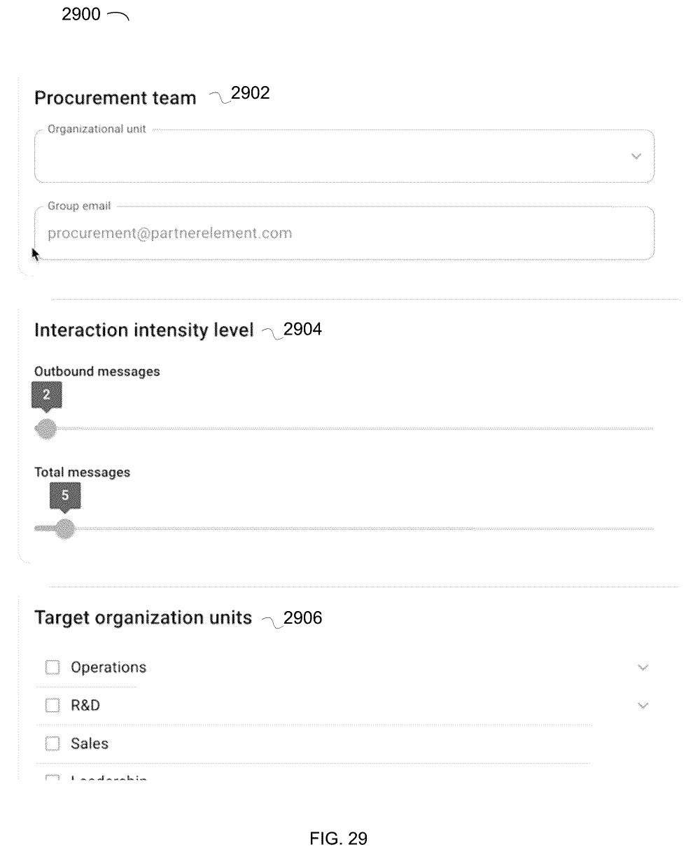

FIG. 29 is a diagram illustrating an embodiment of a user interface displaying an email filtering dashboard. In some embodiments, the user interface of FIG. 29 is provided for display using processor 204 of FIG. 2. In the example shown, email filtering dashboard display 2900 shows procurement team frame 2902, interaction intensity level frame 2904, and target organization units 2906. Procurement team frame 2902 includes an organizational unit selector and a email display. Interaction intensity level frame 2904 includes a display of a number of outbound messages (e.g., a number or a graphic display) and a total number of messages (e.g., a number or a graphic display). Target organization units 2906 includes a selection box for units to target.

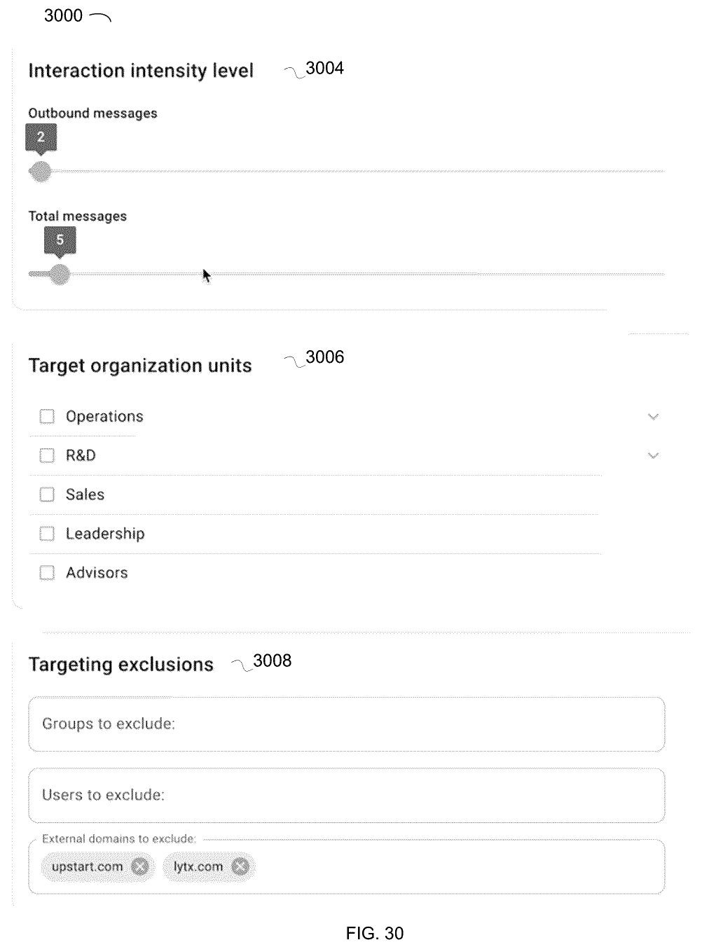

FIG. 30 is a diagram illustrating an embodiment of a user interface displaying an email filtering dashboard. In some embodiments, the user interface of FIG. 30 is provided for display using processor 204 of FIG. 2. In the example shown, email filtering dashboard display 3000 shows interaction intensity level frame 3004, target organization units 3006, targeting exclusions frame 3008. Interaction intensity level frame 3004 includes a display of a number of outbound messages (e.g., a number or a graphic display) and a total number of messages (e.g., a number or a graphic display). Target organization units frame 3006 includes a selection box for units to target. Targeting exclusions frame 3008 includes an entry box for entering groups to exclude, users to exclude from email scanning, and domains to exclude.

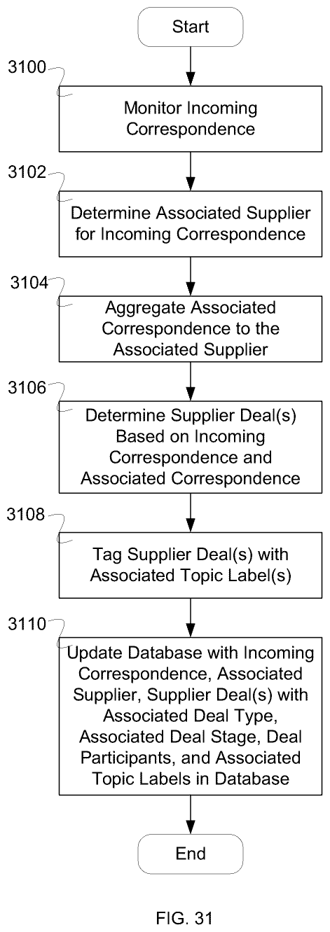

FIG. 31 is a flow diagram illustrating an embodiment of a process for a supplier management service system. In some embodiments, the process of FIG. 31 is executed using processor 204 of FIG. 2. In the example shown, in 3100 incoming correspondence is monitored. For example, incoming messages are monitored (e.g., email correspondence, instant messaging correspondence, etc.). In various embodiments, monitoring comprises one or more of the following: scanning email inboxes, scanning an instant messaging service, or any other appropriate monitoring. In some embodiments, the monitoring filters out incoming emails of texts associated with pre-selected users, groups, domains, etc. In some embodiments, the monitoring allows monitoring of specific pre-selected, users, groups, domains, etc. In 3102, an associated supplier is determined for incoming correspondence. In some embodiments, a supplier detection machine learning model is used to determine an associated supplier for incoming correspondence. In 3104, associated correspondence to the associated supplier is aggregated. For example, correspondence is aggregated into a group to form a potential deal, information related to a supplier, or any other appropriate aggregation. In 3106, one or more supplier deals is/are determined based on the incoming correspondence and the associated correspondence. In some embodiments, a supplier deal of the one or more supplier deals has an associated deal type (e.g., a new contract, an amendment, a renewal, etc.), an associated deal stage (e.g., an exploration, a negotiation, a closure, etc.), and deal participants (e.g., company side participants, supplier side participants, etc.). In 3108, the one or more supplier deals is/are tagged with associated topic label(s). For example, a machine learning model is used to identify associated topic label(s) or keyword(s) in incoming emails or instant messages. In various embodiments, the incoming emails are for selected groups, selected individuals, not for selected groups, not for selected individuals, associated with specific domain names, not associated with specific domain names, or filtered or allowed based on any other appropriate criterion. In various embodiments, the associated topic label comprises one or more of the following: pricing, payments, contract, products, services, catalogs, and/or new engagement, or any other appropriate label. In various embodiments, a deal type and/or a deal stage is are determined using machine learning model(s). In 3110, a database is updated with the incoming correspondence, the associated supplier, the one or more supplier deals with the associated deal type, the associated deal stage, deal participants, and the one or more associated topic labels in the database.

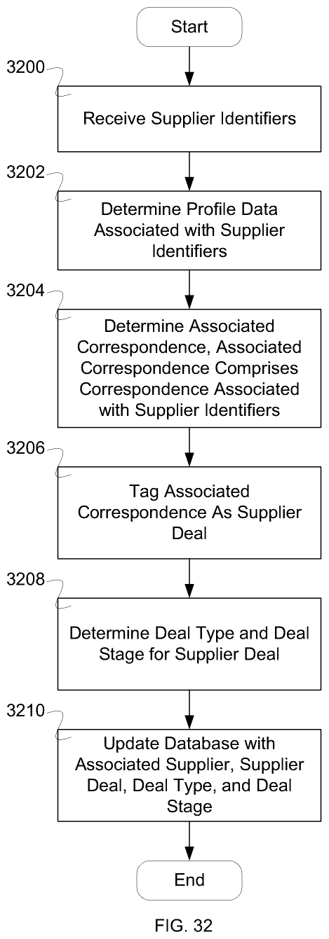

FIG. 32 is a flow diagram illustrating an embodiment of a process for a supplier management service system. In some embodiments, the process of FIG. 32 is executed using processor 204 of FIG. 2. In the example shown, in 3200 supplier identifiers are received. For example, a supplier identifier such as a name, a domain in the form of a supplier email or a website, a tax identifier, an EIN, or any other appropriate identifier is received. In 3202, profile data is associated with supplier identifiers. In some embodiments, known supplier profile data is reconciled with incoming supplier identifiers. For example, the profile data is determined by determining a domain name associated with a supplier associated with a supplier identifier, validating a domain name associated with a supplier of the one or more supplier identifiers, matching a supplier with the one or more supplier identifiers with a company in a third-party database, or any other appropriate determination. In some embodiments, the third-party database comprises a company information third-party database. In 3204, associated correspondence is determined, where associated correspondence comprises correspondence associated with supplier identifiers. For example, supplier correspondence is aggregated related to potential purchases from a supplier. In some embodiments, the correspondence comprises email correspondence or instant messaging correspondence. In some embodiments, determining the correspondence comprises scanning email inboxes or scanning an instant messaging service. In some embodiments, correspondence comprises stored correspondence related to a supplier in a database. In 3206, associated correspondence is tagged as a supplier deal. In some embodiments, the correspondence is tagged with associated topic labels. In some embodiments, tagging the correspondence includes using a machine learning model to identify the one or more associated topic labels. In various embodiments, a topic label of the associated topic labels comprises one or more of: pricing, payments, contract, products, services, catalogs, new engagement, and/or any other appropriate label. In 3208, a deal type and a deal stage are determined for the supplier deal. For example, machine learning models are used to identify a deal type (e.g., a new contract, an amendment, a renewal, etc.) and deal stage (e.g., exploration, negotiation, closure, etc.) based on the supplier correspondence and information derived from the correspondence and from related correspondence in the database. In 3210, a database is updated with associated supplier, supplier deal, deal type, and deal stage. In some embodiments, supplier identifiers, associated correspondence, and associated topic labels are stored in database.

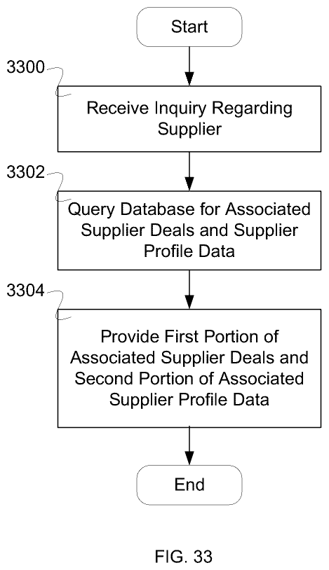

FIG. 33 is a flow diagram illustrating an embodiment of a process for a supplier management service system. In some embodiments, the process of FIG. 33 is executed using processor 204 of FIG. 2. In the example shown, in 3300 an inquiry is received regarding a supplier. In 3302, a database is queried for associate correspondence and profile data of a supplier. In 3304, a first portion of supplier deals and a second portion of associated supplier profile data are provided. In some embodiments, the first portion comprises the associated correspondence related to a selected tag. In various embodiments, tag comprises one or more of the following: a predetermined number of most recent contacts with the supplier, a predetermined number of most recent correspondences with the supplier, a predetermined number of most recent topics with the supplier, or any other appropriate tag. In some embodiments, the first portion and/or the second portion comprises a recommendation related to the supplier. In some embodiments, the first portion and/or the second portion comprises a risk related to the supplier. In some embodiments, the first and/or second portion comprises a status related to the supplier. In some embodiments, the first and/or second portion comprises a fitness level related to the supplier. In some embodiments, the first and/or second portion comprises a set of contacts, internal and/or external, related to the supplier. In some embodiments, the first and/or second portion comprises a set of contacts, internal and/or external, that serve in specifically designated roles related to the relationship with the supplier, such as a primary contact, account owner, support contact, and/or procurement owner. In some embodiments, the one or more of these set of contacts is associated with a set of predefined outreach messages which are manually triggered bu the user to generate text associated with the relevant contact, such as an introductory email to the primary contact requesting further information about the contact's prior relationship to the supplier.

In some embodiments, the supplier management service system is a procurement-centric SaaS platform that empowers a company with early insights into ongoing supplier deals to facilitate company-wide coordination of supplier interactions.

In some embodiments, the supplier management service system scans a designated company email domain and detects prospective deals with suppliers through keyword and language pattern recognition in third-party messages. All messages related to the same deal are collectively referred to as interactions. After detection, interactions are assigned an engagement stage to indicate location in the purchasing process. Prospective deals are assigned to the exploration, negotiation, or closing engagement stage to help procurement teams prioritize resourcing and efforts. Using supplier management service system, a procurement team can engage individual employees or entire teams across the company to provide timely assistance on new deals or renewals.

In some embodiments, the supplier management service system only accesses the data a system administrator allows during the setup process. Using custom inclusion and exclusion rules, a company can choose which email inboxes are automatically scanned. For example, the supplier management service system can be configured to only scan the Research & Development team's inboxes, excluding certain individuals, if desired. Coupled with this, the supplier management service system only accesses emails involving third-party email domains, i.e., emails sent to or received from third parties; the product is not designed to scan emails that are solely among company personnel.

In some embodiments, the supplier management service system only accesses the data a system administrator allows during the setup process. Using custom inclusion and exclusion rules, a company can choose which email inboxes are automatically scanned. For example, the supplier management service system can be configured to only scan the Research & Development team's inboxes, excluding certain individuals, if desired. Coupled with this, the supplier management service system only accesses emails involving third-party email domains, i.e., emails sent to or received from third parties; the product is not designed to scan emails that are solely among company personnel.

In some embodiments, for the supplier management service system, only users with the Administrator role can make changes to global settings, and the client company can designate who has this privilege. A common setup is for the IT team to hold the administrator role, and the supplier management service system can also serve as a company's administrator during setup or on a long-term basis if preferred.

In some embodiments, the supplier management service system streams email copies to its servers. After the copies are processed by the supplier management service system's machine learning service, they are deleted from the supplier management service system environment. The supplier management service system might store de-identified copies to improve the accuracy of supplier detection.

In some embodiments, the supplier management service system analyzes email metadata and/or email content to detect conversations. In some embodiments, the analysis of the emails is augmented by cross-referencing email metadata to external data sources, such as email domains to an external database of companies (e.g., Crunchbase, ZoomInfo, etc.), email addresses to an external database of known individual contact addresses (e.g., Microsoft Active Directory, Google Workspaces, RocketReach, etc.). In some embodiments, the analysis of email metadata includes directly observable information, such as sender, recipients, and thread ID (e.g., derived from either RFC2822 in the email itself or an appropriate “threadId” value in the API for the email service). In various embodiments, the analysis of email metadata includes indirectly computed information, such as the frequency of email exchanges over a set window of time, the inclusion or expansion of key individuals on a given email, an overlapping set (partial or full) of parties on different email threads, or any other appropriate information. In some embodiments, the analysis of email content includes directly observable information, such as the presence of large sections of repeated text across emails (e.g., quote blocks, whether in-line or appended to a response). In some embodiments, the analysis of email is performed by machine learning models which have been trained against prior, known, labeled data sets composed of both examples and counterexamples of email conversations. In some embodiments, these machine learning models provide output in the form of a confidence interval based on the similarity score as it relates to the training data used to create the model. In some embodiments, these machine learning models provide output as a binary value (e.g. Yes/No, True/False, 0/1, etc.).

In some embodiments, once the supplier management service system's machine learning models detect a potential supplier conversation, it only surfaces which employees are talking to which supplier, the particular engagement stage of the activity, relevant dates, and how many emails were exchanged. Nothing else from the emails, such as email subject lines, content, and attachments, is accessible in the user interface or otherwise exposed to users by the supplier management service system.

In some embodiments, the supplier management service system's machine learning models are able to detect potential supplier conversations. When these models scan inboxes and emails to provide a user with the supplier management service system's services, the models improve based on the information being scanned. Continuous improvement through exposure to new information helps the machine learning models become more accurate and precise, which in turn enables us to provide a user with continued services.

In some embodiments, the data is encrypted at rest and protected inside the supplier management service system's virtual private cloud (VPC) in a cloud service provider. The supplier management service system's do not provide data to any third parties besides the sub-processors approved by the organization, such as a cloud service provider. The encryption keys live in a separate environment only accessible by the supplier management service system's internal systems.

In some embodiments, the supplier management service system only keeps emails for as long as needed to detect supplier communications. Generally, most emails are deleted after a few seconds, but occasionally, they can be stored for up to three months—or the maximum time permitted by the customer's email retention policy—to troubleshoot and improve system performance. the supplier management service system might store de-identified copies to improve the accuracy of supplier detection.

In some embodiments, the supplier management service system integrates with the email system as well as a human resources system to display an employee's team and position. Without it, only employee names and emails are shown. In some embodiments, the supplier management service system integrates with enterprise resource systems and/or contract management platforms to help a procurement team prioritize supplier deals using historical spend data and active contracts.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
monitor incoming correspondence;
determine an associated supplier for the incoming correspondence;
aggregate associated correspondence to the associated supplier;
determine one or more supplier deals based on the incoming correspondence and the associated correspondence, wherein a supplier deal of the one or more supplier deals has an associated deal type, an associated deal stage, and deal participants;
tag the supplier deal with one or more associated topic labels; and
update a database with the incoming correspondence with the associated supplier, the one or more supplier deals with the associated deal type, the associated deal stage, deal participants, and the one or more associated topic labels in the database; and
a memory coupled to the processor and configured to provide the processor with instructions.

2. The system as in claim 1, wherein the incoming correspondence comprises email correspondence and/or instant messaging correspondence.

3. The system as in claim 1, wherein the associated supplier comprises an existing supplier or a prospective supplier.

4. The system as in claim 1, wherein monitoring incoming correspondence comprises scanning email inboxes and/or scanning an instant messaging service.

5. The system as in claim 1, wherein a deal participant of the deal participants comprises a supplier contact or an employee.

6. The system as in claim 1, wherein determining the associated supplier uses a supplier detection machine learning model.

7. The system as in claim 1, wherein determining the associated supplier in the incoming correspondence includes using a machine learning model to determine one or more of the following: an input message, a sender, a recipient, a cc address, a message subject, and/or a message body.

8. The system as in claim 7, wherein aggregating the associated correspondence uses a machine learning model using the one or more of the input message, the sender, the recipient, the cc address, the message subject, and/or the message body.

9. The system as in claim 1, wherein tagging the incoming correspondence includes using a machine learning model to identify the one or more associated topic labels.

10. The system as in claim 1, wherein a topic label of the one or more associated topic labels comprises one or more of: pricing, payments, contract, products, services, catalogs, and/or new engagement.

11. The system as in claim 1, wherein:
the interface is further configured to receive one or more supplier identifiers, wherein a supplier identifier of the one or more supplier identifiers comprises a name, a domain in a form of a supplier email or a website, a tax identifier, or an EIN; and
wherein the processor is further configured to:
determine profile data associated with the one or more supplier identifiers;
store the one or more supplier identifiers and the profile data in the database.

12. The system as in claim 11, wherein determining the profile data includes one or more of the following: determining a domain name associated with a supplier of the one or more supplier identifiers, validating a domain name associated with the supplier of the one or more supplier identifiers, and/or matching the supplier with the one or more supplier identifiers with a company in a third-party database.

13. The system as in claim 12, wherein the third-party database comprises a company information third-party database.

14. The system as in claim 1, wherein:
the interface is further configured to display the one or more supplier deals between teams and suppliers in a given time frame; and enables querying the database.

15. The system as in claim 1, wherein:
the interface is further configured to receive an inquiry regarding a supplier; and
wherein the processor is further configured to:
query the database for associated correspondence and associated tags of the supplier; and
provide a first portion of the associated correspondence and a second portion of the associated tags of the supplier.

16. The system as in 15, wherein the first portion comprises the associated correspondence related to a selected tag.

17. The system as in 16, wherein the selected tag comprises a predetermined number of most recent contacts with the supplier.

18. The system as in 16, wherein the selected tag comprises a predetermined number of most recent correspondences with the supplier.

19. The system as in 16, wherein the selected tag comprises a predetermined number of most recent topics with the supplier.

20. The system as in 15, wherein the first portion comprises a recommendation related to the supplier.

21. The system as in 15, wherein the first portion comprises a risk related to the supplier.

22. The system as in 15, wherein the first portion comprises a status related to the supplier.

23. The system as in 15, wherein the first portion comprises a health related to the supplier.

24. A method, comprising:
monitoring incoming correspondence;
determining, using a processor, an associated supplier for the incoming correspondence;
aggregating associated correspondence to the associated supplier;
determining one or more supplier deals based on the incoming correspondence and the associated correspondence, wherein a supplier deal of the one or more supplier deals has an associated deal type, an associated deal stage, and deal participants;
tagging the supplier deal with one or more associated topic labels; and
updating a database with the incoming correspondence with the associated supplier, the one or more supplier deals with the associated deal type, the associated deal stage, deal participants, and the one or more associated topic labels in the database.

25. A computer program product embodied in a non-transitory computer readable medium and comprising computer instructions for:
monitoring incoming correspondence;
determining, using a processor, an associated supplier for the incoming correspondence;
aggregating associated correspondence to the associated supplier;
determining one or more supplier deals based on the incoming correspondence and the associated correspondence, wherein a supplier deal of the one or more supplier deals has an associated deal type, an associated deal stage, and deal participants;
tagging the supplier deal with one or more associated topic labels; and
updating a database with the incoming correspondence with the associated supplier, the one or more supplier deals with the associated deal type, the associated deal stage, deal participants, and the one or more associated topic labels in the database.
